(19) United States
(12) Patent Application Publication
(10) Pub. No.: US 2025/0377220 A1
(43) Pub. Date: Dec. 11, 2025

(54) SYSTEMS, METHODS, AND TECHNIQUES FOR POSITIONING A SENSOR DEVICE

(71) Applicant: Allegro MicroSystems, LLC, Manchester, NH (US)

(72) Inventors: Ahmad Nour Halawani, Heidelberg (DE); Emil Pavlov, Heidelberg (DE)

(73) Assignee: Allegro MicroSystems, LLC, Manchester, NH (US)

(21) Appl. No.: 18/734,254

(22) Filed: Jun. 5, 2024

(51) Int. Cl. G01D 5/14; G01B 7/31

(52) U.S. Cl. CPC G01D 5/145; G01B 7/31

(57) ABSTRACT

Disclosed are example systems, methods, and techniques for positioning a sensor device. In particular, described are example systems, methods, and techniques for positioning a sensor device such that the sensor device is aligned with a rotation axis of a target. Using the systems, methods, and techniques disclosed herein, a sensor device may be centered over a rotation axis of a target in an end-of-shaft sensing application. The systems, methods, and techniques disclosed herein may be used to align a sensor device with a rotation axis of a target in a manner that is more efficient than traditional approaches for calibrating a sensor device.

### BACKGROUND

Sensor devices are often used to monitor parameters of a system. For example, sensor devices may be used to measure an angle of rotation of a rotation object, such as a rotor of an electric motor. The measured angle information may then be used to control the motor. For example, a controller may continuously receive a measured angle of rotation of the rotor, and may use this information to commutate the motor. That is, the measured angle information may be used by the controller to switch currents in motor windings, producing magnetic fields that cause the rotor to rotate. The controller can then control aspects of the motor, such as speed and torque, based on the measured angle information. Numerous applications in industries, spanning from industrial automation and robotics, to electronic power steering and motor position sensing, may require monitoring of a rotation angle of a rotating shaft.

### SUMMARY

Disclosed are example systems, methods, and techniques for positioning a sensor device. In particular, described are example systems, methods, and techniques for positioning a sensor device such that the sensor device is aligned with a rotation axis of a target. Using the systems, methods, and techniques disclosed herein, a sensor device may be centered over a rotation axis of a target in an end-of-shaft sensing application. The systems, methods, and techniques disclosed herein may be used to align a sensor device with a rotation axis of a target in a manner that is more efficient than traditional approaches for calibrating a sensor device.

In accordance with some embodiments, there is provided a method of aligning a sensor device to a magnetic target. The method comprises identifying values related to a magnetic field generated by the magnetic target at rotation angles of the magnetic target, and determining a phase shift angle of the sensor device from a reference point based on the identified values. The method also comprises determining a movement vector based on the determined phase shift angle, and providing the movement vector for aligning the sensor device to the magnetic target.

In some embodiments, the method further comprises identifying values related to the magnetic field generated by the magnetic target at rotation angles of the magnetic target over 360 degrees of rotation.

In further embodiments, the values related to the magnetic field are identified based on signals generated by a Hall plate of the sensor device, the Hall plate being positioned perpendicular to an axis around which the magnetic target rotates.

In still further embodiments, determining the phase shift angle further comprises determining phase shifts between the identified values and corresponding reference values, and calculating an average of the determined phase shifts as the determined phase shift angle.

In some embodiments, determining the phase shift angle further comprises calculating a Hilbert transform of the identified values to determine first values, and calculating a Hilbert transform of reference values to determine second values. Determining the phase shift angle also comprises calculating a complex conjugate of the determined second values to determine third values, and calculating phase shifts based on the first and third values. Determining the phase shift angle still further comprises calculating an average of the phase shifts as the determined phase shift angle.

In further embodiments, the identified values comprise first identified values, and the method further comprises identifying second values related to the magnetic field generated by the magnetic target at rotation angles of the magnetic target after the sensor device has been moved along the movement vector. The method still further comprises determining that the sensor device is aligned with the magnetic target based on the identified second values.

In still further embodiments, the movement vector is determined by calculating sine and cosine functions of the determined phase shift angle.

In some embodiments, a misalignment of the sensor device to the magnetic target causes at least some of the identified values to have values that are not zero.

In further embodiments, the identified values comprise first identified values, and the method further comprises simulating a magnetic field generated by the magnetic target based on parameters of the magnetic target, and determining a distance to move the sensor device along the movement vector based on the simulated magnetic field. The method also comprises identifying second values related to the magnetic field generated by the target at rotation angles of the magnetic target after the sensor device has been moved the determined distance along the movement vector. The method still further comprises determining that the sensor device is aligned with the magnetic target based on the identified second values.

In still further embodiments, the identified values comprise first identified values, and the method further comprises iteratively determining a distance to move the sensor device along the movement vector and identifying additional values related to the magnetic field generated by the magnetic target at rotation angles of the magnetic target after each time the sensor device is moved until the identified additional values indicate that the sensor device is aligned with the magnetic target.

Furthermore, in accordance with some embodiments, there is provided a sensor device comprising a memory storing instructions and a controller. The controller, when executing the instructions, is configured to identify values related to a magnetic field generated by a magnetic target at rotation angles of the magnetic target, and determine a phase shift angle of the sensor device from a reference point based on the identified values. The controller, when executing the instructions, is further configured to determine a movement vector based on the determined phase shift angle, and provide the movement vector for aligning the sensor device to the magnetic target.

In some embodiments, the controller, when executing the instructions, is further configured to identify values related to the magnetic field generated by the magnetic target at rotation angles of the magnetic target over 360 degrees of rotation.

In further embodiments, the sensor device further comprises a Hall plate, the Hall plate being positioned perpendicular to an axis around which the magnetic target rotates.

In still further embodiments, determining the phase shift angle further comprises determining phase shifts between each of the identified values and corresponding reference values, and calculating an average of the phase shifts as the determined phase shift angle.

In some embodiments, the identified values comprise first identified values, and the controller, when executing the instructions, is further configured to identify second values related to the magnetic field generated by the magnetic target at rotation angles of the magnetic target after the sensor device has been moved along the movement vector. The controller, when executing the instructions, is still further configured to determine that the sensor device is aligned with the magnetic target based on the identified second values.

In further embodiments, the controller, when executing the instructions, is further configured to determine the movement vector by calculating sine and cosine functions of the determined phase shift angle.

In still further embodiments, the identified values comprise first identified values, and the controller, when executing the instructions, is further configured to simulate a magnetic field generated by the magnetic target based on parameters of the magnetic target, and determine a distance to move the sensor device along the movement vector based on the simulated magnetic field. The controller, when executing the instructions, is also configured to identify second values related to the magnetic field generated by the magnetic target at rotation angles of the magnetic target after the sensor device has been moved the determined distance along the movement vector. The controller, when executing the instructions, is still further configured to determine that the sensor device is aligned with the magnetic target based on the identified second values.

In some embodiments, the identified values comprise first identified values, and the controller, when executing the instructions, is further configured to iteratively determine a distance to move the sensor device along the movement vector and identify additional values related to the magnetic field generated by the magnetic target at rotation angles of the magnetic target after each time the sensor device is moved until the identified additional values indicate that the sensor device is aligned with the magnetic target.

Additionally, in accordance with some embodiments, there is provided a non-transitory computer-readable medium storing instructions that, when executed by a processor, cause the processor to identify values related to a magnetic field generated by a magnetic target at rotation angles of the magnetic target, and determine a phase shift angle of a sensor device from a reference point based on the identified values. The instructions, when executed by the processor, further cause the controller to determine a movement vector based on the determined phase shift angle, and provide the movement vector for aligning a sensor device to the target.

In some embodiments, the instructions, when executed, further cause the processor to identify values related to the magnetic field generated by the magnetic target at rotation angles of the magnetic target over 360 degrees of rotation.

In further embodiments, the identified values comprise first identified values and the instructions, when executed, further cause the processor to identify second values related to the magnetic field generated by the magnetic target at rotation angles of the magnetic target after the sensor device has been moved along the movement vector. The instructions, when executed, further cause the processor to determine that the sensor device is aligned to the magnetic target based on the identified second values.

In still further embodiments, the identified values comprise first identified values and the instructions, when executed, further cause the processor to simulate a magnetic field generated by the magnetic target based on parameters of the magnetic target, and determine a distance to move the sensor device along the movement vector based on the simulated magnetic field. The instructions, when executed, also cause the processor to identify second values related to the magnetic field generated by the magnetic target at rotation angles of the magnetic target after the sensor device has been moved the determined distance along the movement vector. The instructions, when executed, further cause the processor to determine that the sensor device is aligned with the magnetic target based on the identified second values.

In some embodiments, the identified values comprise first identified values, and the instructions, when executed, further cause the processor to iteratively determine a distance to move the sensor device along the movement vector and identify additional values related to the magnetic field generated by the magnetic target at rotation angles of the magnetic target after each time the sensor device is moved until the identified additional values indicate that the sensor device is aligned with the magnetic target.

Before explaining example embodiments consistent with the present disclosure in detail, it is to be understood that the disclosure is not limited in its application to the details of constructions and to the arrangements set forth in the following description or illustrated in the drawings. The disclosure is capable of being practiced and carried out in various ways. Also, it is to be understood that the phraseology and terminology employed herein, as well as in the abstract, are for the purpose of description and should not be regarded as limiting.

It is to be understood that both the foregoing general description and the following detailed description are explanatory only and are not restrictive of the claimed subject matter.

### BRIEF DESCRIPTION OF THE DRAWINGS

The accompanying drawings are incorporated in and constitute part of this specification. The drawings, together with the description, illustrate and serve to explain the principles of various example embodiments of the disclosure.

FIG. 1 shows an example system with an end-of-shaft arrangement for detecting rotation angles of a target.

FIG. 2A shows a graph of example measured rotation angles of a target versus actual rotation angles of the target.

FIG. 2B shows a graph of example angle errors of measured rotation angles of a target versus actual rotation angles of the target.

FIG. 3 shows a block diagram of an example sensor device, consistent with embodiments of the present disclosure.

FIG. 4 shows a top view of an example target and example positions of a sensor device in relation to the target.

FIG. 5A shows a graph of an example simulation of magnetic field strengths sensed along three axes when the sensor device is centered over a rotation axis of the target and the target is rotated 360 degrees.

FIG. 5B shows a graph of an example simulation of magnetic field strengths sensed along three axes when the sensor device is misplaced to the north of a rotation axis of the target and the target is rotated 360 degrees.

FIG. 5C shows a graph of an example simulation of magnetic field strengths sensed along three axes when the sensor device is misplaced to the south of a rotation axis of the target and the target is rotated 360 degrees.

FIG. 5D shows a graph of an example simulation of magnetic field strengths sensed along three axes when the sensor device is misplaced to the east of a rotation axis of the target and the target is rotated 360 degrees.

FIG. 5E shows a graph of an example simulation of magnetic field strengths sensed along three axes when the sensor device is misplaced to the west of a rotation axis of the target and the target is rotated 360 degrees.

FIG. 6 shows a top view of an example target showing curves (e.g., positive cosine, negative cosine, positive sine, negative sine) associated with magnetic field strengths sensed along a Z axis when the sensor device is misplaced at various positions in relation to the rotation axis of the target and the target is rotated 360 degrees.

FIG. 7 shows a top view of an example target showing phase relationships between curves (sine/cosine) associated with magnetic field strengths sensed along a Z axis when the sensor device is misplaced at various positions in relation to the rotation axis of the target and the target is rotated 360 degrees, with a reference misplacement position set at 0 degrees.

FIG. 8A shows a top view of an example target showing an example misplacement position of a sensor device.

FIG. 8B shows a graph of an example plot associated with magnetic field strengths sensed along a Z axis when the sensor device is misplaced at the position shown in FIG. 8A and the target is rotated 360 degrees, and of an example plot associated with magnetic field strengths that would be sensed along a Z axis when the sensor device is misplaced at a reference misplacement position and the target is rotated 360 degrees.

FIG. 9A shows a top view of an example target showing example misplacement positions of a sensor device.

FIG. 9B shows a graph of an example curve associated with magnetic field strengths sensed along a Z axis when the sensor device is misplaced at one of the positions shown in FIG. 9A and the target is rotated 360 degrees, and of an example curve associated with magnetic field strengths that would be sensed along a Z axis when the sensor device is misplaced at a reference misplacement position and the target is rotated 360 degrees.

FIG. 9C shows a graph of an example curve associated with magnetic field strengths sensed along a Z axis when the sensor device is misplaced at another of the positions shown in FIG. 9A and the target is rotated 360 degrees, and of an example curve associated with magnetic field strengths that would be sensed along a Z axis when the sensor device is misplaced at a reference misplacement position and the target is rotated 360 degrees.

FIG. 9D shows a graph of an example curve associated with magnetic field strengths sensed along a Z axis when the sensor device is misplaced at yet another of the positions shown in FIG. 9A and the target is rotated 360 degrees, and of an example curve associated with magnetic field strengths that would be sensed along a Z axis when the sensor device is misplaced at a reference misplacement position and the target is rotated 360 degrees.

FIG. 9E shows a graph of an example curve associated with magnetic field strengths sensed along a Z axis when the sensor device is misplaced at still another of the positions shown in FIG. 9A and the target is rotated 360 degrees, and of an example curve associated with magnetic field strengths that would be sensed along a Z axis when the sensor device is misplaced at a reference misplacement position and the target is rotated 360 degrees.

FIG. 10 shows a top view of an example target showing phase relationships between curves (sine or cosine) associated with magnetic field strengths sensed along a Z axis when the sensor device is misplaced at various positions in relation to the rotation axis of the target and the target is rotated 360 degrees, with a reference misplacement position set at 0 degrees, and with the plane on which the sensor device is to be fixed split into four quadrants.

FIG. 11A shows a top view of an example target showing example positions at which a sensor device may be misplaced along a vector that bisects the target.

FIG. 11B shows a graph of example curves associated with magnetic field strengths sensed along a Z axis when the sensor device is misplaced at the example positions shown in FIG. 11A and the target is rotated 360 degrees.

FIG. 11C shows a graph of example magnetic field strengths sensed along a Z axis when the sensor device is misplaced at the example positions shown in FIG. 11A and when the target has been rotated to an example rotation angle.

FIG. 12 shows an example process for positioning a sensor device to be aligned with a rotation axis of a target, consistent with embodiments of the present disclosure.

FIG. 13 shows an example computing environment, consistent with embodiments of the present disclosure.

FIG. 14 shows an example computing device, consistent with embodiments of the present disclosure.

The drawings are not necessarily to scale, or inclusive of all elements of a system, emphasis instead generally being placed upon illustrating the concepts, structures, and techniques sought to be protected herein.

### DETAILED DESCRIPTION

Reference will now be made in detail to the embodiments of the disclosure, certain examples of which are illustrated in the accompanying drawings.

In the following description, numerous specific details are set forth regarding the systems, methods, and techniques of the disclosed subject matter, and the environment in which such systems, methods, and techniques operate, to provide a thorough understanding of the disclosed subject matter. After reading the descriptions provided herein, it will be apparent to one skilled in the art, however, that the disclosed subject matter may be practiced without such specific details. It will also be apparent to one skilled in the art that certain features, which are well known within the art, are not described in detail to avoid unnecessary complication of the description of the systems, methods, and techniques described herein. In addition, it will be understood that the embodiments provided below are examples, and that it is contemplated that there are other systems, methods, and techniques that are within the scope of the subject matter disclosed herein.

A magnetic field sensor device may be used to determine a rotation angle of a rotation object. With a magnetic field sensor device, one or more elements of the sensor device that are responsive to a magnetic field may be positioned near a rotation object and may either directly detect a magnetic field generated by the rotation object (e.g., if the rotation object is magnetized) or detect a magnetic field of a magnet attached to the rotation object. A magnetic field angle sensor device may be a good choice for fast, reliable, contactless measurement of the angular position of a system.

An object monitored by a sensor device is often referred to as a target. Accordingly, an object whose characteristics are sensed by the sensor device, such as a magnet or magnetized rotation object, may be referred to as a “target” herein.

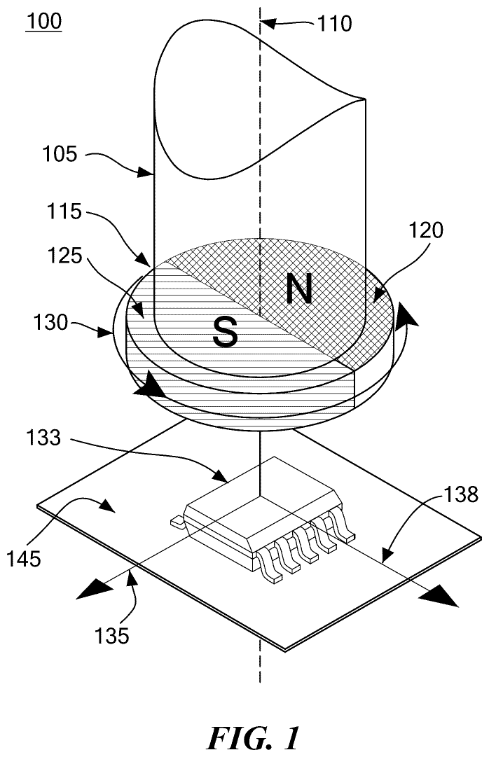

FIG. 1 shows an example system 100 that may be used to measure a rotation angle of a rotation object using a magnetic field sensor device in accordance with example embodiments of the disclosure. In system 100, the rotation object comprises a shaft (e.g., shaft 105 of system 100), such as a rotor, and the rotation object is illustrated as rotating around an axis (e.g., axis 110 of system 100). The rotation object can rotate around the axis clockwise or counterclockwise, or can rotate clockwise at some times and counterclockwise at other times. In FIG. 1, arrow 130 illustrates a clockwise rotation of the rotation object about the axis, when viewed along the axis of rotation (e.g., axis 110 of FIG. 1) from below. Although FIG. 1 illustrates an example system where a shaft or rotor rotates, the disclosure is not so limited. A person of ordinary skill in the art would recognize that magnetic field sensor devices may be used to detect a rotation angle of any object that rotates, not just shafts or rotors, so long as that object is magnetized or has a magnet attached to it.

In some embodiments, a rotation object (e.g., rotation object 105) may be magnetized, such that a magnetic field sensor device may sense a magnetic field generated by the rotation object. Alternatively, a magnet may be attached to a rotation object and the magnet may generate a magnetic field, allowing for detection of the magnetic field by a magnetic field sensor device. The magnet may be attached such that the magnet rotates with the rotation object. For example, FIG. 1 illustrates an example system 100 where a magnet 115 (e.g., disc magnet, ring magnet) has been positioned near an end (e.g., bottom) of rotation object 105. However, the disclosure is not so limited. As one alternative example, a magnet may be positioned near another end (e.g., top) of rotation object 105. In some embodiments, the magnet may be physically attached to a top or bottom of the rotation object.

In example system 100 of FIG. 1, magnet 115 is shown as being a diametrically magnetized disc magnet with a north pole 120 and a south pole 125. However, the disclosure is not limited to this example. A person of ordinary skill in the art would recognize that many forms of magnet may be used, such as any magnet that is circularly symmetrical. Such magnets may include, for example, disc magnets, ring magnets, cylinder magnets, or other forms of magnets that are circularly symmetrical.

A person of ordinary skill in the art would also recognize that a magnet (e.g., magnet 115 of FIG. 1) may be a permanent magnet that stays magnetized once magnetized, a temporary magnet that behaves like a magnet only when near a magnetic field, an electromagnet that behaves like a magnet only when electricity is applied, or any other type of magnet. A person of ordinary skill in the art would recognize that a magnet (e.g., magnet 115 of FIG. 1) may be made of any type of magnetic material, such as neodymium (e.g., neodymium-iron-boron (NdFeB)), samarium cobalt (e.g., SmCo), alnico (e.g., aluminum, nickel, cobalt), ceramic or ferrite (e.g., strontium carbonate, iron oxide), or any other type of magnetic material. Although magnet 115 in FIG. 1 is illustrated as being diametrically magnetized with two poles, the disclosure is not so limited. A person of ordinary skill in the art would recognize that a magnet (e.g., magnet 115 of FIG. 1) may have any number of north and south poles. Although embodiments disclosed herein are discussed primarily with respect to magnets having a single north pole and a single south pole, techniques disclosed herein may be used with magnets having multiple pairs of poles. For such a magnet, the techniques disclosed herein (e.g., process 1200) would be performed to place a sensor device in relation to a particular pole pair to be measured, and would then be repeated to place a sensor device in relation to any different pole pair of the magnet to be measured.

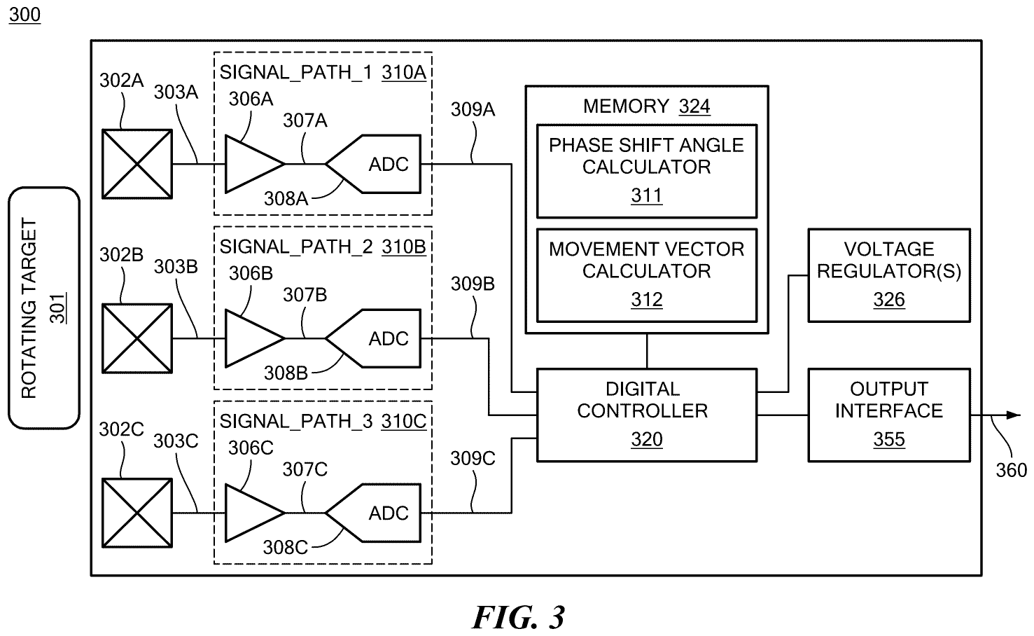

One or more magnetic field sensing elements (see, e.g., magnetic field sensing elements 302A, 302B, 302C of FIG. 3) for sensing a magnetic field of a magnet may be positioned near the magnet. In example system 100 of FIG. 1, for example, a package 133 (e.g., integrated circuit) including one or more magnetic field sensing elements is positioned near magnet 115. System 100 of FIG. 1 is an example of an on-axis (e.g., end-of-shaft) arrangement, in that the one or more magnetic field sensing elements in package 133 are aligned along the rotation axis (e.g., axis 110) of the target (e.g., magnet 115). Package 133 may be positioned on a planar surface 145, such as a printed circuit board (PCB) or other surface, near magnet 115.

In addition to including one or more magnetic field sensing elements, a package (e.g., package 133 of FIG. 1) may also include additional circuitry (see, e.g., FIG. 3) for conditioning and/or processing signals representing the magnetic field generated by the one or more magnetic field sensing elements. Although FIG. 1 illustrates the one or more magnetic field sensing elements and additional circuitry as being included in a package, the disclosure is not so limited. A person of ordinary skill in the art would recognize, for example, that the one or more magnetic field sensing elements and any additional circuitry may be mounted as separate components on a PCB, for example. Alternatively, some components may be included in a package, while other components may be external to the package.

In some embodiments, the one or more magnetic field sensing elements may include at least two magnetic field sensing elements, positioned orthogonally to each other, each having an axis of maximum sensitivity coincident with an axis of a magnetic field. For example, if system 100 of FIG. 1 were mapped to X, Y, and Z axes in a Cartesian coordinate system, axis 135 may be thought of as an X axis, axis 138 may be thought of as a Y axis, and axis 110 may be thought of as a Z axis. In some embodiments, two magnetic field sensing elements may be used to measure an angle of rotation of a target, with one of the magnetic field sensing elements having a respective axis of maximum sensitivity along one of the X and Y axes, and the other magnetic field sensing element having an axis of maximum sensitivity along another of the X and Y axes. It will be appreciated that, although a magnetic field sensing element may be described herein as being sensitive to a particular axis of a magnetic field, a person of skill in the art would recognize that the magnetic field sensing element may also be sensitive to the magnetic field outside that particular axis, but may be maximally sensitive to the magnetic field along that particular axis.

In some embodiments, the one or more magnetic field sensing elements may include three magnetic field sensing elements, positioned orthogonally to each other, each sensitive to the magnetic field along one of the X, Y, and Z axes. For example, in the system of FIG. 1, one magnetic field sensing element in package 133 may be sensitive to a magnetic field along an axis 135 (e.g., X axis), another magnetic field sensing element in package 133 may be sensitive to the magnetic field along an axis 138 (e.g., Y axis) that is orthogonal to axis 135, and another magnetic field sensing element in package 133 may be sensitive to the magnetic field along an axis 110 (e.g., Z axis) that is orthogonal to axis 135 and axis 138. The output of the magnetic field sensing elements may be processed and/or conditioned and sent to one or more controllers of the integrated circuit. The processed signals received by the controller(s) along with their processing circuitry may be referred to as channels, with one channel corresponding to the processed and/or conditioned signal output from a first one of the magnetic field sensing elements, another channel corresponding to the processed and/or conditioned signal output from a second one of the magnetic field sensing elements, and still another channel corresponding to the processed and/or conditioned signal output from a third one of the magnetic field sensing elements.

In response to the magnetic field generated by the target (e.g., magnet 115), the magnetic field sensing elements may each provide a voltage output that is proportional to the magnitude of the sensed magnetic field. The voltage output may vary as the target rotates due to changes in the magnetic field detected by the magnetic field sensing elements as the target rotates. When the magnetic field is sensed over a rotation of the target of 360 degrees, the voltage output from a first one of the magnetic field sensing elements may appear as a sine or cosine curve over the 360 degrees of rotation and the voltage output from a second one of the magnetic field sensing elements may also appear as a sine or cosine curve over the 360 degrees of rotation. One of skill in the art would recognize that a cosine curve is a sine curve phase shifted by 90 degrees. Accordingly, the same curve can be represented as a sine or cosine function, and will as such sometimes be referred to as a “sine/cosine” curve herein.

In some embodiments, a phase shift may exist between a sine/cosine curve output by a first magnetic field sensing element and a sine/cosine curve output by a second magnetic field sensing element. In system 100 of FIG. 1, for example, a first magnetic field sensing element may be configured to be sensitive to the magnetic field generated by target 115 along axis 135 (e.g., X axis) and a second magnetic field sensing element positioned orthogonal to the first magnetic field sensing element may be configured to be sensitive to the magnetic field generated by target 115 along axis 138 (e.g., Y axis). As a result, the sine/cosine curves output from the two magnetic field sensing elements over a rotation of 360 degrees may be phase separated by 90 degrees.

In the example shown in FIG. 1, there is only one pole pair for an entire 360 degree rotation of the rotation object, so a period of the sine/cosine curve may correspond to a complete 360 degree rotation of the rotation object. However, as discussed above, the disclosure is not so limited and a target may have multiple pole pairs, in which case a period of a sine/cosine curve may correspond to a rotation across one of the multiple pole pairs.

In some embodiments where magnetic field sensing elements are positioned orthogonal to each other, a rotation angle of the target may be calculated. For example, if package 133 includes a first magnetic field sensing element configured to sense the magnetic field generated by target 115 along one axis 135 (e.g., X axis), and includes a second magnetic field sensing element positioned orthogonal to the first magnetic field sensing element and configured to sense the magnetic field generated by target 115 along axis 138 (e.g., Y axis), then an inverse tangent function (i.e., arctan function) may be applied to the voltages measured from the magnetic field sensing elements at any given time to calculate an angle of rotation of the target at that time. For example, the two-argument arctangent function atan 2, commonly used in computing and mathematics, may be used to calculate a rotation angle of the target based on the voltage signals output from the two orthogonal magnetic field sensing elements at a given time. Various other techniques may be used to determine a measured rotation angle of the target instead of using an inverse tangent function, such as techniques using a lookup table, a polynomial fit, or a coordinate rotation digital computer (CORDIC) calculation. The calculations and/or processing required to determine the measured angle may be carried out by one or more controllers. That is, one or more controllers may receive signals from the channels and determine a measured angle of rotation of the target based on the channel signals using an inverse tangent function, lookup table, polynomial fit, or CORDIC calculation.

Design of a system using magnetic field sensors, such as a rotation angle measurement system as described above, may depend on the needs of a particular application. Factors such as arrangement, desired air gap between the sensor device and the target, desired accuracy, and anticipated temperature range, among other factors, may be taken into account in designing such a system. In a magnetic field rotation angle measurement system, errors in rotation angle measurements may be caused, for example, from misalignment of a sensor device to a target, among other factors. Misplacement of a sensor device in a system, even if slight, may cause errors in rotation angle measurement. As a result, the rotation angle of a target measured by the sensor device may not be identical to the actual rotation angle of the target at any given point in time. These differences between the measured rotation angle and the actual rotation angle are angle measurement errors, and may be referred to as nonlinearities.

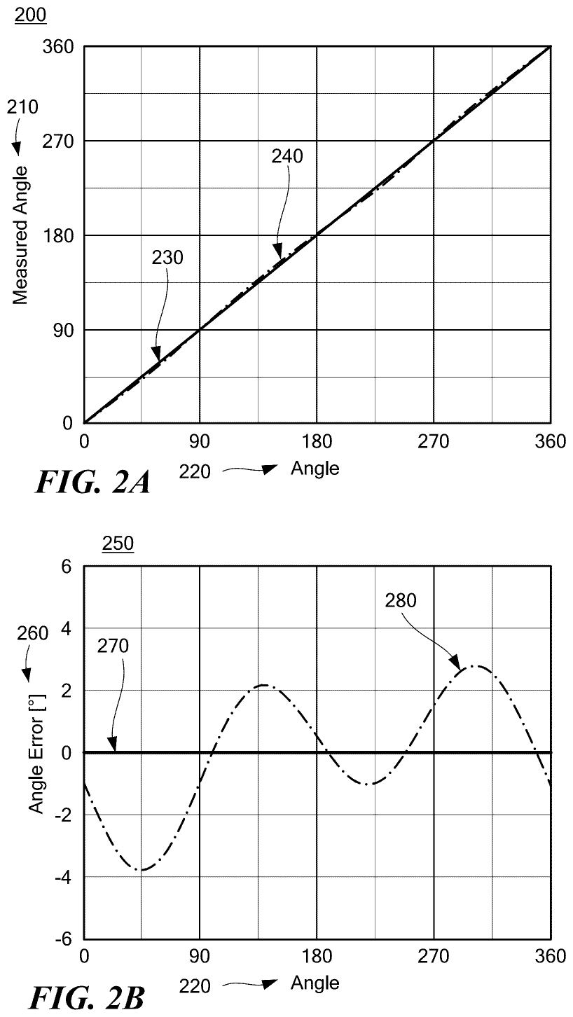

For example, FIG. 2A shows a graph 200 having an X-axis 220 that represents an actual angle of rotation of a target. Y-axis 210 of graph 200 represents a measured angle of rotation of the target. Plot 230 represents ideal measurements of rotation angles of the target over 360 degrees of rotation. Plot 240 represents measurements of rotation angles of the target over 360 degrees of rotation by an example sensor device. FIG. 2B shows a graph 250 having an X-axis 220 that represents an actual angle of rotation of a target. Y-axis 260 of graph 250 represents angle error between a measured angle of rotation of the target and the actual angle of rotation of the target. Plot 270 represents ideal measurements of rotation angles of the target over 360 degrees of rotation. Plot 280 represents measurements of rotation angles of the target over 360 degrees of rotation by an example sensor device. In the example shown in FIG. 2B, the rotation angle measured by the magnetic sensor device may be almost 4 degrees off from the actual rotation angle of the target at around 45 degrees of rotation, approximately 2 degrees off from the actual rotation angle of the target at around 135 degrees of rotation, and approximately 3 degrees off from the actual rotation angle of the target at around 290 degrees of rotation, as just some examples.

One approach used to mitigate such errors is to perform an initial calibration after the sensor device has been installed in a system to determine measured angle errors and to then use those angle errors to linearize the output of the sensor device. For example, after the sensor device has been installed in a system, the target to be measured may be rotated 360 degrees and the sensor device may measure rotation angles around the 360 degrees of rotation. Rotation angle measurements around the 360 degrees of rotation may also be recorded by an accurate, high-resolution encoder device. The rotation angle measurements recorded by the sensor device may then be compared with the rotation angle measurements recorded by the encoder device, and differences between the two measurements may be recorded as angle error values over the 360 degrees of rotation. These angle error values may then be stored and used to adjust future rotation angle measurements recorded by the sensor device to compensate for errors. The process of determining these angle error values and using them to compensate for rotation angle measurement errors may be referred to as linearizing the sensor device.

In end-of-shaft rotation angle measurement systems using magnetic field sensors, centering the magnetic field sensing elements of a sensor device with respect to the axis of rotation of a target may also compensate for some of these nonlinearities. For example, as discussed above, an angle of rotation may be calculated by measuring a magnetic field along two axes (e.g., X-axis and Y-axis), and measurements of the magnetic field along these axes may be most accurate when the magnetic field sensing elements are aligned with the rotation axis, such that the magnetic field strength along a third axis (e.g., Z-axis) orthogonal to the other two axes is ideally zero. For example, a sensor device with three orthogonal magnetic field sensing elements may be in an ideal alignment with the rotation axis of the target when a magnetic field sensing element sensitive to the magnetic field generated by the target along an X-axis and a magnetic field sensing element sensitive to the magnetic field generated by the target along a Y-axis are positioned at an equal distance from the axis of rotation of the target, and a magnetic field sensing element sensitive to the magnetic field generated by the target along a Z-axis measures a magnetic field strength of zero. One approach used to center the magnetic field sensing elements to mitigate errors resulting from misplacement is to place the sensor device at various positions in a plane in an end-of-shaft system, measure magnetic field strength and/or rotation angle over 360 degrees of rotation at each of these positions, and then to fix the sensor device at a position which yielded the most accurate results. Such a process may be time consuming and inefficient.

Embodiments of the present disclosure provide systems, methods, and techniques for positioning a sensor device. In particular, described are example systems, methods, and techniques for positioning a sensor device such that the sensor device is aligned with a rotation axis of a target. More particularly, the systems, methods, and techniques disclosed herein may be used to align the magnetic field sensing elements within a sensor device with a rotation axis of a target, so as to improve accuracy in measuring magnetic field strength of the target and/or rotation angle of the target. Using the systems, methods, and techniques disclosed herein, a sensor device may be aligned with a rotation axis of a target in an end-of-shaft sensing application in a manner that is more efficient than using traditional approaches.

Example systems, methods, and techniques disclosed herein provide for a positioning a sensor device in an end-of-shaft application. A sensor device may be positioned at a location in a plane next to a target. The target may then be rotated and magnetic field strength values may be measured along Z-axes at different positions (e.g., in the X-axis and/or Y-axis directions) in a plane around the axis of rotation of the target as the target rotates. The magnetic field strength values over the rotation of the target may appear, for example, as a sine/cosine curve for each position of the sensor device. The measured magnetic field strength values may then be compared to magnetic field values that would be sensed along a Z-axis by a sensor device positioned at a reference position in the plane, to determine a phase shift between the measured values and the reference values. A movement vector may be determined based on this phase shift, and the sensor device may be moved along the movement vector to align the sensor device with the rotation axis of the target.

FIG. 3 is a block diagram of a sensor device 300, consistent with embodiments of the present disclosure, wherein like reference numbers indicate like elements. For example, sensor device 300 may be a magnetic field angle sensor device configured to sense the magnetic field of a target and to use the sensed magnetic field to determine a measured rotation angle of the target. This target is illustrated in FIG. 3 as rotating target 301. Target 301 may correspond, for example, to target 115 of FIG. 1. As previously discussed, a rotating target may be a magnet attached to a rotating object that may rotate with the rotating object, or alternatively may be a rotating object that is itself magnetized.

As discussed above, a sensor device (e.g., sensor device 300) may include one or more magnetic field sensing elements. For example, FIG. 3 illustrates sensor device 300 as comprising three magnetic field sensing elements, magnetic field sensing element 302A, magnetic field sensing element 302B, and magnetic field sensing element 302C. As discussed above, the magnetic field sensing elements may be positioned orthogonal to each other, so as to be sensitive to orthogonal components of a magnetic field.

A magnetic field sensing element may be any type of element sensitive to a magnetic field. For example, a magnetic field sensing element may be a Hall-effect element (e.g., a Hall plate), a magnetoresistance element, or a magnetotransistor element. For example, a magnetic field sensing element may be a Hall-effect element such as a planar Hall element, a vertical Hall element, or a circular vertical Hall (CVH) element. A magnetic field sensing element may instead be a magnetoresistance element, such as an Indium Antimonide (InSb) element, a giant magnetoresistance (GMR) element (e.g., a spin valve element), an anisotropic magnetoresistance (AMR) element, a tunneling magnetoresistance (TMR) element, or a magnetic tunnel junction (MTJ) element. A magnetic field sensing element may be a receiving coil field sensing element. A magnetic field sensing element may be a single element, or alternatively may include two or more magnetic field sensing elements arranged in one of various configurations, such as a half bridge or full (Wheatstone) bridge. Depending on the type of sensor device and application requirements, a magnetic field sensing element may be a device made of a type IV semiconductor material such as Silicon (Si) or Germanium (Ge), or of a type III-V semiconductor material such as Gallium-Arsenide (GaAs) or an Indium compound such as Indium-Antimonide (InSb).

In some embodiments, multiple magnetic field sensing elements in a sensor device may be of the same type of magnetic field sensing element. For example, sensor device 300 may include three magnetic field sensing elements 302A, 302B, and 302C which may be of the same type (e.g., from the list above) and positioned orthogonal to one another. For example, each of magnetic field sensing elements 302A, 302B, and 302C may be a Hall plate sensing element, with one sensing element (e.g., magnetic field sensing element 302A) placed perpendicular to one axis (e.g., X-axis 135 of FIG. 1) to be sensitive to the magnetic field along that axis, another sensing element (magnetic field sensing element 302B) placed perpendicular to another axis (e.g., Y-axis 138 of FIG. 1) to be sensitive to the magnetic field along that axis, and another sensing element (magnetic field sensing element 302C) placed perpendicular to another axis (e.g., Z-axis 110 of FIG. 1) to be sensitive to the magnetic field along that axis. In some embodiments, there may be different types of magnetic field sensing elements that work together in a sensor device. For example, sensor device 300 may include three magnetic field sensing elements 302A, 302B, and 302C, which may be of different types.

In some embodiments, magnetic field sensing elements 302A, 302B, 302C may experience a change in resistance in response to a nearby magnetic field. For example, a magnetic field generated by rotating target 301 may cause a change in resistance in magnetic field sensing elements 302A, 302B, 302C. A voltage may then be detected by magnetic field sensing elements 302A, 302B, 302c. The detected voltage may be proportional to the resistance of a magnetic field sensing element and may therefore be representative of the magnetic field that induced the resistance within the magnetic field sensing element. As previously discussed above, by placing magnetic field sensing elements orthogonal to each other, a measured rotation angle of the target (e.g., target 301) may then be determined based on the voltages generated by the two magnetic field sensing elements at any given time (e.g., using an inverse tangent function (arctan), two-argument arctangent function atan 2, lookup table, polynomial fit, CORDIC calculation).

The voltages provided by the magnetic field sensing elements (e.g., magnetic field sensing elements 302A, 302B, 302C) may be processed and/or conditioned along channels, or signal paths (e.g., Signal_Path_1 310A, Signal_Path_2 310B, Signal_Path_3 310C) before being sent to a controller (e.g., digital controller 320). A signal path for processing/conditioning a detected voltage may include, for example, an amplifier and an analog-to-digital converter. For example, FIG. 3 illustrates Signal_Path_1 310A as including an amplifier 306A that receives a detected voltage signal (e.g., signal 303A) from magnetic field sensing element 302A. An amplified version of the voltage signal (e.g., signal 307A) may then be sent to analog-to-digital converter 308A. Analog-to-digital converter 308A may then convert the analog voltage signal to a digital signal (e.g., signal 309A) and may send the digital signal to digital controller 320. Similarly, FIG. 3 illustrates Signal_Path_2 310B as including an amplifier 306B that receives a detected voltage signal (e.g., signal 303B) from magnetic field sensing element 302B. An amplified version of the voltage signal (e.g., signal 307B) may then be sent to analog-to-digital converter 308B. Analog-to-digital converter 308B may then convert the analog voltage signal to a digital signal (e.g., signal 309B) and may send the digital signal to digital controller 320. FIG. 3 further illustrates Signal_Path_3 310C as including an amplifier 306C that receives a detected voltage signal (e.g., signal 303C) from magnetic field sensing element 302C. An amplified version of the voltage signal (e.g., signal 307C) may then be sent to analog-to-digital converter 308C. Analog-to-digital converter 308C may then convert the analog voltage signal to a digital signal (e.g., signal 309C) and may send the digital signal to digital controller 320.

As discussed above, a sensor device may also include one or more controllers. The controller(s) may include digital and/or analog circuitry. For example, sensor device 300 of FIG. 3 includes a digital controller 320. The controller may include any suitable type of processing circuitry, such as an application-specific integrated circuit (ASIC), a field programmable gate array (FPGA), a CORDIC processor, a special-purpose processor, synchronous digital logic, asynchronous digital logic, a general-purpose processor (e.g., MIPS processor, x86 processor), etc. The one or more controllers may also include a clock. The clock may timestamp when voltages from magnetic field sensing elements are recorded (e.g., timestamp with an elapsed amount of time measured by the clock), such that, for example, determined angle measurements and the times at which the voltages used to calculate the angle measurements were received may be stored in memory (e.g., memory 324). One of skill in the art would recognize that the clock need not be internal to the one or more controllers, and may instead by an external component connected to the one or more controllers.

The sensor device may also include one or more memories. For example, sensor device 300 of FIG. 3 includes a memory 324. The memory may include any suitable type of volatile and/or non-volatile memory. In some embodiments, the memory may be a non-transitory computer-readable medium. By way of example, memory 324 may include a random-access memory (RAM), a dynamic random-access memory (DRAM), an electrically-erasable programmable read-only memory (EEPROM), and/or any other suitable type of memory. The memory may store instructions, that when executed by the controller(s), cause the controller(s) to carry out certain determinations, steps, processes, and/or calculations. For example, FIG. 3 illustrates memory 324 as storing instructions that, when executed by the controller, cause the controller(s) to (1) calculate phase shift angles (e.g., phase shift angle calculator instructions 311) and (2) calculate a movement vector (e.g., movement vector calculator instructions 312). These instructions will be discussed in further detail herein.

The sensor device may include one or more voltage regulators. For example, sensor 300 of FIG. 3 includes voltage regulator(s) 326. Voltage regulator(s) may, for example, convert or regulate voltage to provide a stable power supply to the controller(s) (e.g., digital controller 320), magnetic field sensing element(s) (e.g., magnetic field sensing elements 302A, 302B, 302C), amplifier(s) (e.g., amplifier(s) 306A, 306B, 306C), analog-to-digital converter(s) (e.g., analog-to-digital converters 308A, 308B, 308C), one or more memories (e.g., memory 324), output interface (e.g., output interface 355), and/or any other circuitry in sensor device 300.

The sensor device may also include one or more output interfaces. For example, sensor device 300 includes an output interface 355. An output interface may include any suitable type of interface for outputting a signal (e.g., output signal 360). The output interface(s) may include one or more of a wired or wireless interface. By way of example, the output interface(s) may include a current modulator for sending information along a conductor via current pulses, a voltage modulator for sending information along a conductor via voltage pulses, an Inter-Integrated Circuit (I²C) interface, a Controller Area Network (CAN) bus interface, a WiFi interface, an Ethernet interface, a Universal Serial Bus (USB) interface, a local area network (LAN) interface, a cellular (e.g., 5G) interface, and/or any other suitable type of interface.

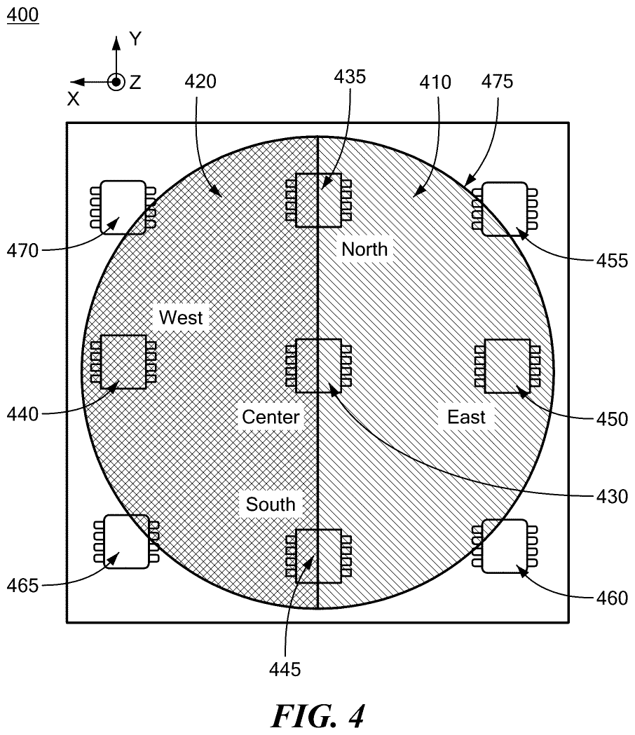

FIG. 4 shows a top view 400 of an example target 475 and example positions of a sensor device (shown as an integrated circuit (IC)) in relation to the target. Target 475 may have one south pole 420 and one north pole 410, though the disclosure is not so limited. Target 475 may be, for example, target 301 of FIG. 3 and/or target 115 of FIG. 1. A sensor device (e.g., package 133, sensor device 300) may be positioned on a target (e.g., target 115, target 301), or positioned at a location (e.g., location in an X-axis direction and/or a Y-axis direction) in a plane (e.g., at a location on a PCB) and separated from the target by an air gap. It may be desired that the sensor device be positioned such that it is centered with the rotation axis of the target, or more particularly such that the magnetic field sensing elements within the sensor device are aligned with the rotation axis of the target. In top view 400, such a position may correspond to position 430, referred to herein as a “center” position. Top view 400 also shows example positions that are not in alignment with the rotation axis of the target, such as positions 435 (“north”), 445 (“south”), 450 (“east”), 440 (“west”), 455 (“northeast”), 460 (“southeast”), 465 (“southwest”), and 470 (“northwest”). These example positions and names of positions are provided here for discussion purposes to assist in describing the disclosed embodiments, and should not be regarded as limiting. As discussed above with respect to sensor device 300 of FIG. 3, a sensor device may include three magnetic field sensing elements (e.g., Hall plate elements), each of which is positioned to be sensitive to an axis of a magnetic field generated by a target. For example, one magnetic field sensing element may be positioned to be sensitive to the magnetic field along an X-axis, one magnetic field sensing element may be positioned to be sensitive to the magnetic field along a Y-axis, and one magnetic field sensing element may be positioned to be sensitive to the magnetic field along a Z-axis.

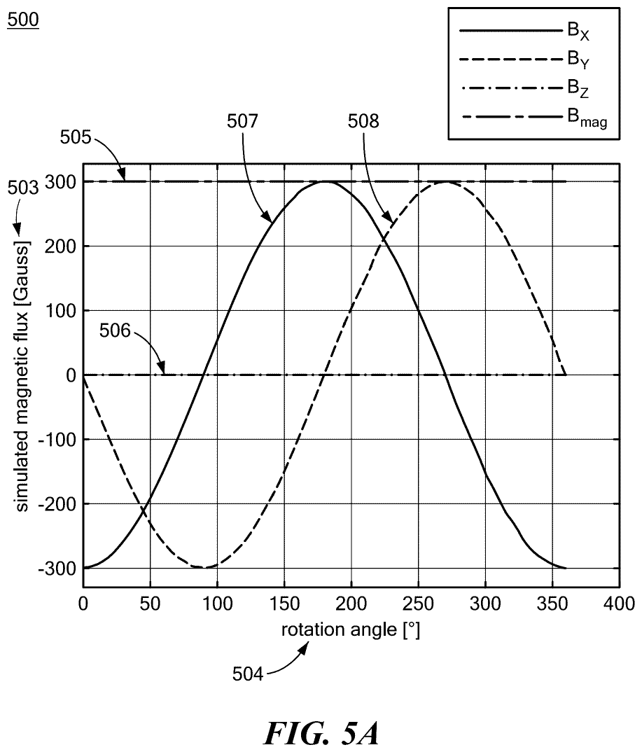

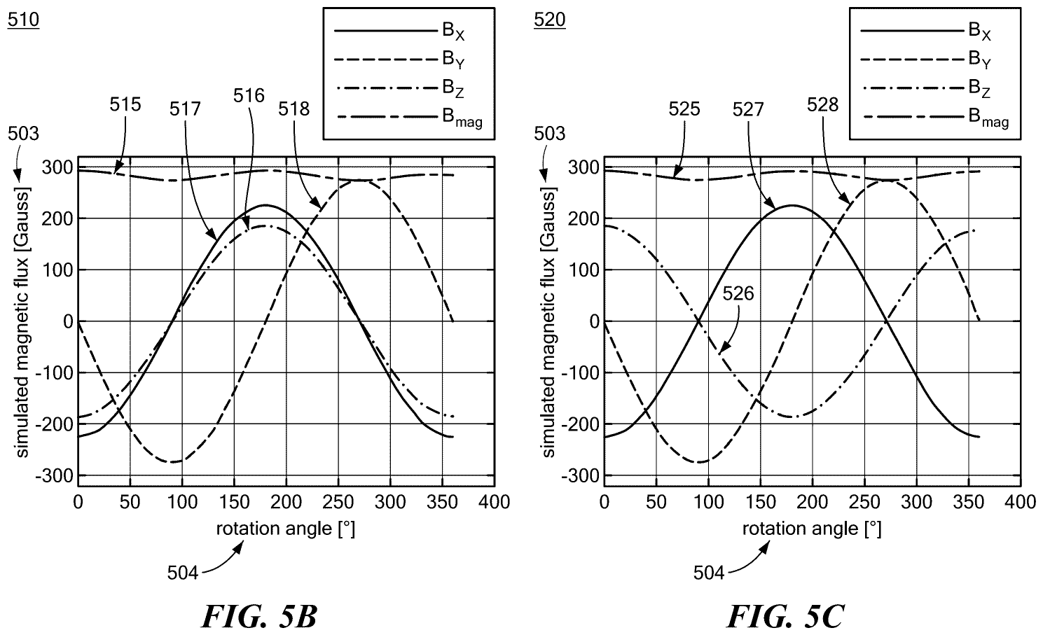

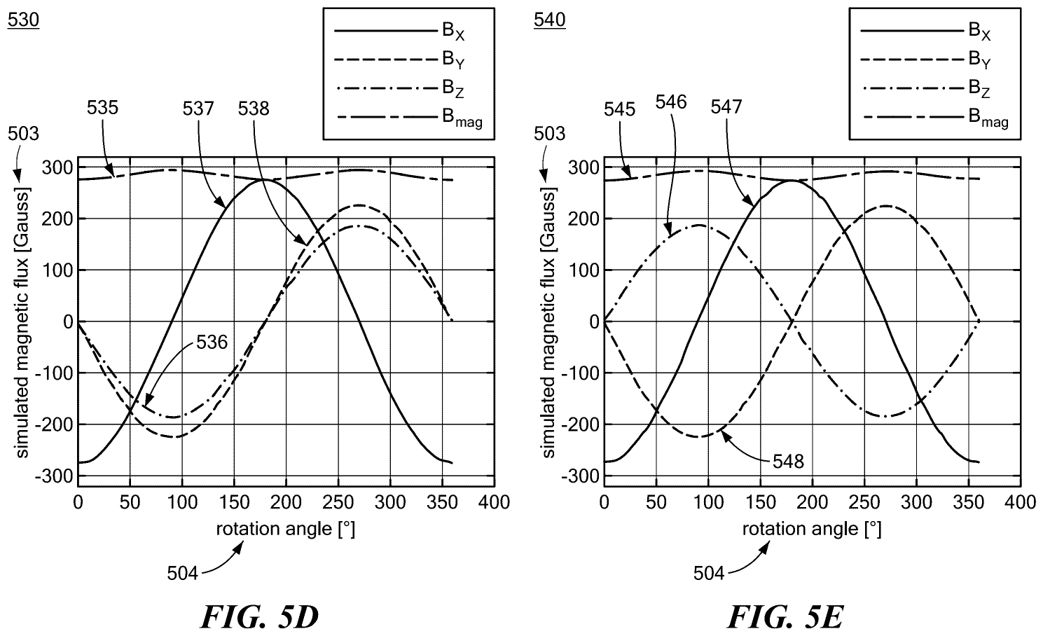

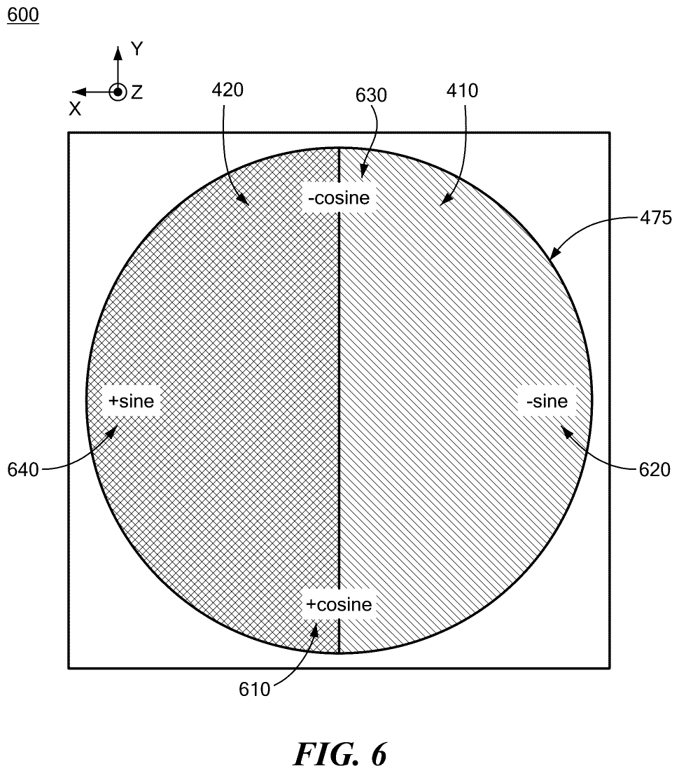

FIGS. 5A-5E show graphs of example simulations of magnetic field strengths sensed along three axes (X, Y, Z) by a sensor device when the sensor device is located in different positions (e.g., positions 430, 435, 445, 450, 440, respectively, of FIG. 4) in a plane and the target is rotated 360 degrees. For example, as discussed above, a first magnetic field sensing element of the sensor device may be configured to be sensitive to a magnetic field along one axis (e.g., X-axis) and may measure the strength of the magnetic field along that axis, a second magnetic field sensing element of the sensor device may be configured to be sensitive to the magnetic field along another axis (e.g., Y-axis) and may measure the strength of the magnetic field along that axis, and a third magnetic field sensing element of the sensor device may be configured to be sensitive to the magnetic field along yet another axis (e.g., Z-axis) and may measure the strength of the magnetic field along that axis. Each of these graphs has an X-axis 504 representing a rotation angle of the target in degrees, and a Y-axis 503 representing a simulation of a measured magnetic field strength (or flux) in Gauss. Each of these graphs also has plots of the simulated magnetic field strength to be measured along the X-axis, Y-axis, and Z-axis by a sensor device, and a plot of the magnitude of the overall magnetic flux to be measured by the sensor device, over 360 degrees of rotation of the target. The graphs in FIGS. 5A-5E correspond to simulations where the X, Y, and Z axes are defined as in FIG. 4, where the orientation of the target in FIG. 4 corresponds to 0 degrees of rotation, and where the target is rotated clockwise. Although the Y-axis is defined in units of Gauss, magnetic field strength may in reality be measured by a magnetic field sensing element in some other way that is representative of magnetic field strength, such as a voltage that is proportional to magnetic field strength as described above.

FIG. 5A shows a graph 500 of an example simulation of magnetic field strengths measured along three axes (X, Y, Z) by a sensor device when the sensor device is centered over a rotation axis of the target (e.g., position 430 (“center”) of FIG. 4) and the target is rotated 360 degrees. That is, the plots of graph 500 correspond to magnetic field strengths that may be measured by magnetic field sensing elements of the sensor device when the sensor device is ideally aligned with the target. Plot 506 corresponds to the magnetic field strength measured along a Z-axis over 360 degrees of rotation of the target. As shown in graph 500, at this ideal position, the magnetic field strength measured along the Z-axis may be flat at 0 Gauss over 360 degrees of rotation of the target, as all the magnetic flux vectors of the magnetic field should be tangential and not perpendicular to the magnetic field sensing element (e.g., Hall plate) at this position. By contrast, the magnetic field strength measured by a magnetic field sensing element along the Y-axis over 360 degrees of rotation of the target (as shown by plot 508) may appear as a negative sine curve. The magnetic field strength measured by a magnetic field sensing element along the X-axis over 360 degrees of rotation of the target (as shown by plot 507) may appear as a negative cosine curve. A magnitude of the overall magnetic flux measured at this ideal position may also be constant over 360 degrees of rotation of the target (as shown by plot 505), and in this example is 300 Gauss.

FIG. 5B shows a graph 510 of an example simulation of magnetic field strengths sensed along three axes (X, Y, Z) by a sensor device when the sensor device is misaligned and positioned at a north position (e.g., position 435 (“north”) of FIG. 4) and the target is rotated 360 degrees. Graph 510 shows that the magnetic field strength measured along the Y-axis over 360 degrees of rotation of the target (as shown by plot 518) again appears as a negative sine curve, and the magnetic field strength measured along the X-axis over 360 degrees of rotation of the target (as shown by plot 517) again appears as a negative cosine curve. However, graph 510 also shows that, given the misplacement of the sensor device, the sensor device now measures a significant magnetic field strength along the Z-axis (as shown by plot 516) over 360 degrees of rotation of the target. As shown, when the sensor device is placed at the north position, the measured magnetic field strength along the Z-axis appears as a negative cosine curve over 360 degrees of rotation (as shown by plot 516). Additionally, when the sensor device is misplaced at this position, the overall magnetic field strength measured by the sensor device has changed from a constant amount to a second order trigonometric function (as shown by plot 515), such that the overall magnetic field strength measured by the sensor device is not the same at every rotation angle.

FIG. 5C shows a graph 520 of an example simulation of magnetic field strengths sensed along three axes (X, Y, Z) by a sensor device when the sensor device is misaligned and positioned at a south position (e.g., position 445 (“south”) of FIG. 4) and the target is rotated 360 degrees. Graph 520 shows that the magnetic field strength measured along the Y-axis over 360 degrees of rotation of the target (as shown by plot 528) again appears as a negative sine curve, and the magnetic field strength measured along the X-axis over 360 degrees of rotation of the target (as shown by plot 527) again appears as a negative cosine curve. Graph 510 also shows that, given the misplacement of the sensor device, the sensor device measures a significant magnetic field strength along the Z-axis (as shown by plot 526) over 360 degrees of rotation of the target. As shown, when the sensor device is placed at the south position, the measured magnetic field strength along the Z-axis appears as a positive cosine curve over 360 degrees of rotation of the target (as shown by plot 526). That is, while the magnetic field strength measured along the X-axis and Y-axis are identical in the FIG. 5B and FIG. 5C examples, the magnetic field strength measured along the Z-axis is flipped from a negative cosine curve over 360 degrees of rotation of the target for the FIG. 5B example to a positive cosine curve over 360 degrees of rotation of the target for the FIG. 5C example. Additionally, when the sensor device is misplaced at this position, the overall magnetic field strength measured by the sensor device is the same second order trigonometric function as in the FIG. 5B example (as shown by plot 525).

FIG. 5D shows a graph 530 of an example simulation of magnetic field strengths sensed along three axes (X, Y, Z) by a sensor device when the sensor device is misaligned and positioned at an east position (e.g., position 450 (“east”) of FIG. 4) and the target is rotated 360 degrees. Graph 530 shows that the magnetic field strength measured along the Y-axis over 360 degrees of rotation of the target (as shown by plot 538) again appears as a negative sine curve, and the magnetic field strength measured along the X-axis over 360 degrees of rotation of the target (as shown by plot 537) again appears as a negative cosine curve. Graph 530 also shows that, given the misplacement of the sensor device, the sensor device measures a significant magnetic field strength along the Z-axis (as shown by plot 536) over 360 degrees of rotation. As shown, when the sensor device is placed at the east position, the measured magnetic field strength along the Z-axis appears as a negative sine curve over 360 degrees of rotation (as shown by plot 536). Additionally, when the sensor device is misplaced at this position, the overall magnetic field strength measured by the sensor device is a second order trigonometric function, such that the overall magnetic field strength measured by the sensor device is not the same at every rotation angle. The overall magnetic field strength measured by the sensor device is a second order trigonometric function that is phase shifted from the second order trigonometric function of the overall magnetic field strength shown in FIGS. 5B and 5C (as shown by plot 535).

FIG. 5E shows a graph 540 of an example simulation of magnetic field strengths sensed along three axes (X, Y, Z) by a sensor device when the sensor device is misaligned and positioned at a west position (e.g., position 440 (“west”) of FIG. 4) and the target is rotated 360 degrees. Graph 540 shows that the magnetic field strength measured along the Y-axis over 360 degrees of rotation of the target (as shown by plot 548) again appears as a negative sine curve, and the magnetic field strength measured along the X-axis over 360 degrees of rotation of the target (as shown by plot 547) again appears as a negative cosine curve. Graph 540 also shows that, given the misplacement of the sensor device, the sensor device measures a significant magnetic field strength along the Z-axis (as shown by plot 546) over 360 degrees of rotation. As shown, when the sensor device is placed at the west position, the measured magnetic field strength along the Z-axis appears as a positive sine curve over 360 degrees of rotation (as shown by plot 546). That is, while the magnetic field strength measured along the X-axis and Y-axis are identical in the FIG. 5D and FIG. 5E examples, the magnetic field strength measured along the Z-axis is flipped from a negative sine curve over 360 degrees of rotation for the FIG. 5D example to a positive sine curve over 360 degrees of rotation for the FIG. 5E example. Additionally, when the sensor device is misplaced at this position, the overall magnetic field strength measured by the sensor device is the same second order trigonometric function as in the FIG. 5D example (as shown by plot 545).

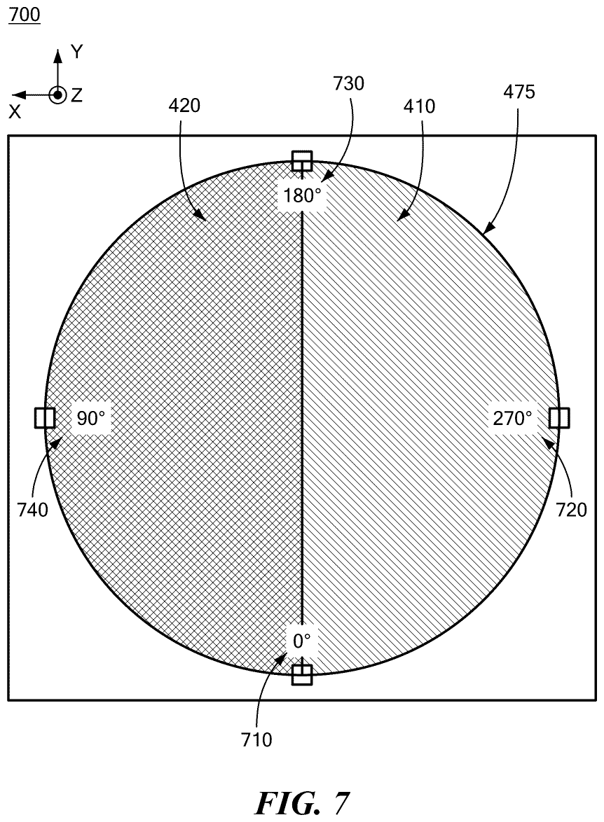

FIG. 6 shows a top view 600 of an example target showing curves (positive sine, negative sine, positive cosine, or negative cosine) associated with magnetic field strengths sensed along a Z-axis when the sensor device is misplaced at various positions in relation to the rotation axis of the target and the target is rotated 360 degrees. That is, as discussed above with respect to FIG. 5B, when a sensor device is misplaced at a “north” position (e.g., “north” of FIG. 4), the magnetic field strength sensed along the Z-axis over 360 degrees of rotation of the target may correspond to a negative cosine curve 630. Similarly, with respect to FIG. 5C, when a sensor device is misplaced at a “south” position (see, e.g., “south” of FIG. 4), the magnetic field strength sensed along the Z-axis over 360 degrees of rotation of the target may correspond to a positive cosine curve 610. With respect to FIG. 5D, when a sensor device is misplaced at an “east” position (see, e.g., “east” of FIG. 4), the magnetic field strength sensed along the Z-axis over 360 degrees of rotation of the target may correspond to a negative sine curve 640. With respect to FIG. 5E, when a sensor device is misplaced at a “west” position (see, e.g., “west” of FIG. 4), the magnetic field strength sensed along the Z-axis over 360 degrees of rotation of the target may correspond to a positive sine curve 620.

One of these example misplacement positions may be selected as a reference misplacement position, and every misplacement position may then be represented with a phase shift from the selected reference misplacement position. For example, the south misplacement position (e.g., position 445 (“south”) of FIG. 4) may be set as the selected reference misplacement position and associated with a phase shift of 0 degrees, and phase shifts of other misplacement positions may then be expressed in relation to the reference misplacement position. However, the disclosure is not so limited. A person of ordinary skill in the art would recognize that any misplacement position could be selected as a reference misplacement position, and that other misplacement positions may then be represented with a phase shift from the selected reference misplacement position.

FIG. 7 shows a top view of an example target showing phase relationships between curves (sine/cosine) associated with magnetic field strengths sensed along a Z-axis when a sensor device is misplaced at different positions in relation to the rotation axis of the target and the target is rotated 360 degrees, and when the south position is selected as the reference misplacement position. As shown in FIG. 7, as the selected reference misplacement position, the south misplacement position (corresponding to a positive cosine curve over 360 degrees of rotation of the target) may be associated with a phase shift of 0 degrees 710. A phase shift of 90 degrees 740 may be associated with a “west” misplacement position, a phase shift of 180 degrees 730 may be associated with a “north” misplacement position, and a phase shift of 270 degrees 720 may be associated with an “east” misplacement position. One of ordinary skill in the art would understand that any misplacement position may be selected as a reference misplacement position from which phase shifts of the other misplacement positions may be derived. Selecting the south misplacement position as the reference position is just an example here.

With the south position selected as the reference misplacement position, the positive cosine curve will be associated with a phase shift of 0 degrees. The sine/cosine curve at any location may then expressed as:

$${B}_{Z} = A cos ( θ + φ ) \qquad Equation l$$

where B_{Z} is the magnitude of the magnetic field strength along the Z-axis, A is an amplitude, θ is the angle of rotation of the target, and φ is the phase shift with respect to the selected reference misplacement position. The amplitude A is a constant and is dependent on the distance of the misplacement position of the sensor device from the center position where the sensor device would be ideally aligned with the center of the target, and on the airgap distance between the target and the sensor device. When the south misplacement position is selected to be the reference misplacement position, φ is 0 degrees at this position.

At any misplacement position of a sensor device (i.e., any position not centered in ideal alignment with the rotation axis of the target), a nonzero magnetic field strength may be sensed along a Z-axis. As discussed above, the magnetic field strength along a Z-axis for any misplacement position of the sensor device may be represented by its relationship to the magnetic field strength along a Z-axis for a selected reference misplacement position (e.g., positive cosine associated with the south misplacement position). That is, for any misplacement position along a radius from an ideal center position, the phase shift φ of Equation 1 will be nonzero, except for at the selected reference misplacement position. Thus, a radius from the center position along which a sensor device is misplaced may be determined by determining the phase shift φ of Equation 1. Any point on the radius may then be represented by:

$$point on radius = {Ae}^{- i φ} \qquad Equation 2$$

where A is the amplitude constant discussed above with respect to Equation 1 and φ is the phase shift discussed above with respect to Equation 1.

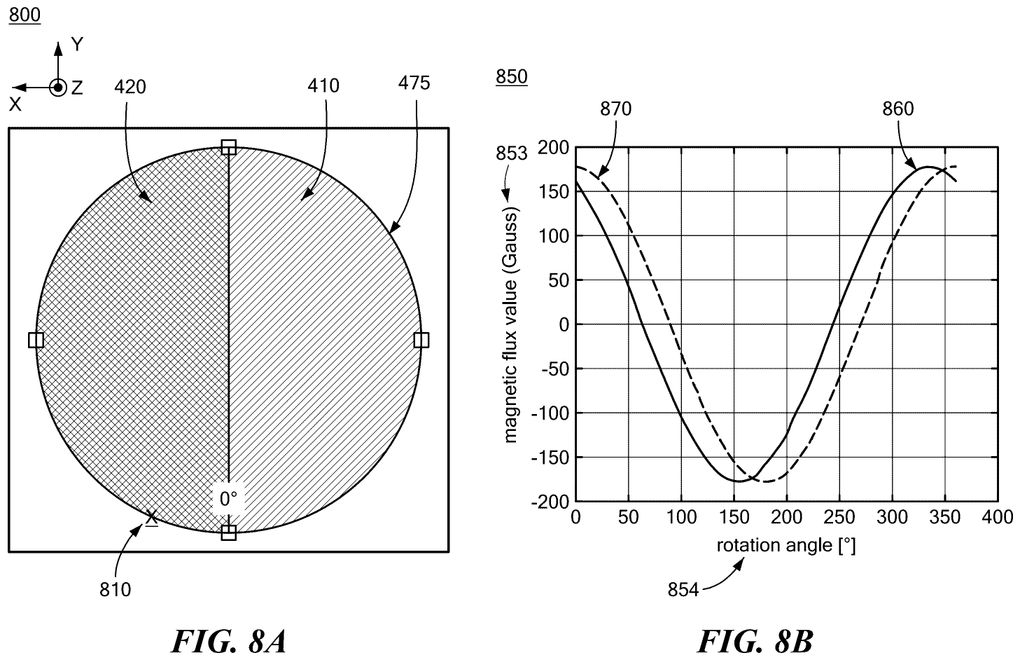

FIG. 8A shows a top view 800 of an example target showing an example misplacement position 810 of a sensor device. FIG. 8B shows a graph 850 plotting simulated magnetic field strengths measured by a sensor device along a Z-axis at the example misplacement position shown in FIG. 8A over 360 degrees of rotation of the target. Graph 850 has an X-axis 854 representing a rotation angle of the target in degrees, and a Y-axis 853 representing a simulation of a measured magnetic field strength (or flux) in Gauss. Plot 860 corresponds to simulated magnetic field strengths measured by a sensor device that is misplaced at misplacement position 810 of FIG. 8A, over 360 degrees of rotation of a target. Plot 870 corresponds to simulated magnetic field strengths that would be measured by the sensor device at the selected reference misplacement position (e.g., position 445 (“south”) of FIG. 4), which as shown and as previously described is a positive cosine function. The radius on which the sensor device is misplaced from an ideal center position may then be determined by determining the phase shift of plot 860 (representing magnetic field strengths along a Z-axis measured by the sensor device) from plot 870 (representing magnetic field strengths that would be measured along a Z-axis at the selected reference misplacement position (e.g., “south” position)). The amplitude of the positive cosine curve (e.g., plot 870) may be set to the same amplitude as the amplitude of the sine/cosine curve resulting from magnetic field strengths measured along a Z-axis by the sensor device over 360 degrees of rotation of the target (e.g., plot 860). That is, the peak of the positive cosine curve may be set to the same value as the value of the highest magnetic field strength measured along a Z-axis by the sensor device over 360 degrees of rotation. Thus, by measuring magnetic field strength along a Z-axis over 360 degrees of rotation and determining that peak value, the positive cosine curve associated with the reference misplacement position may be determined mathematically using that peak value as its amplitude.

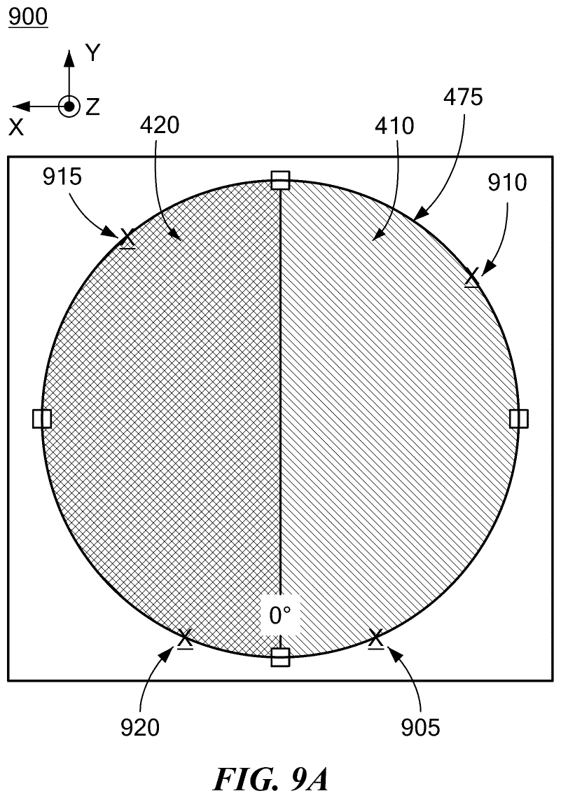

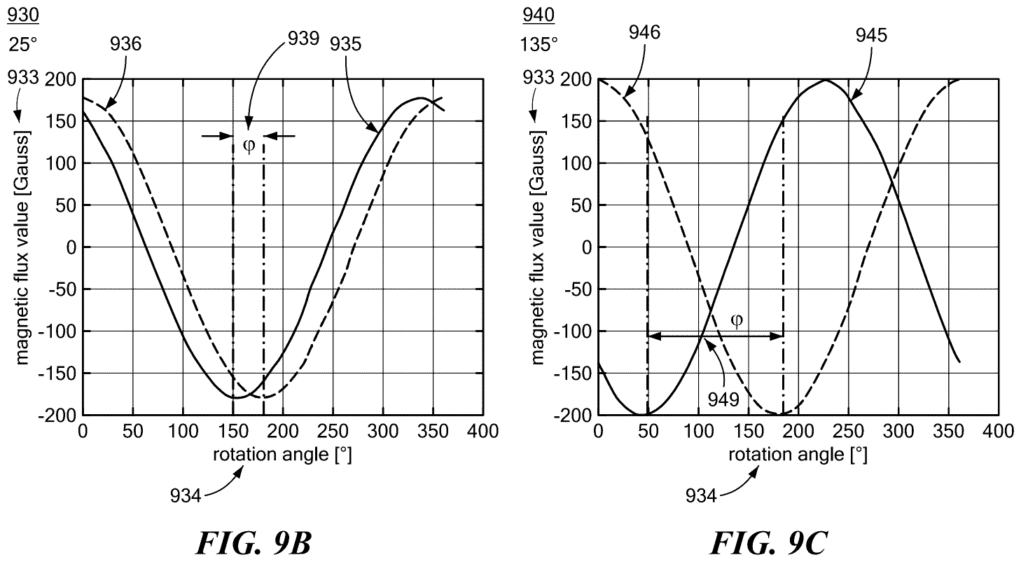

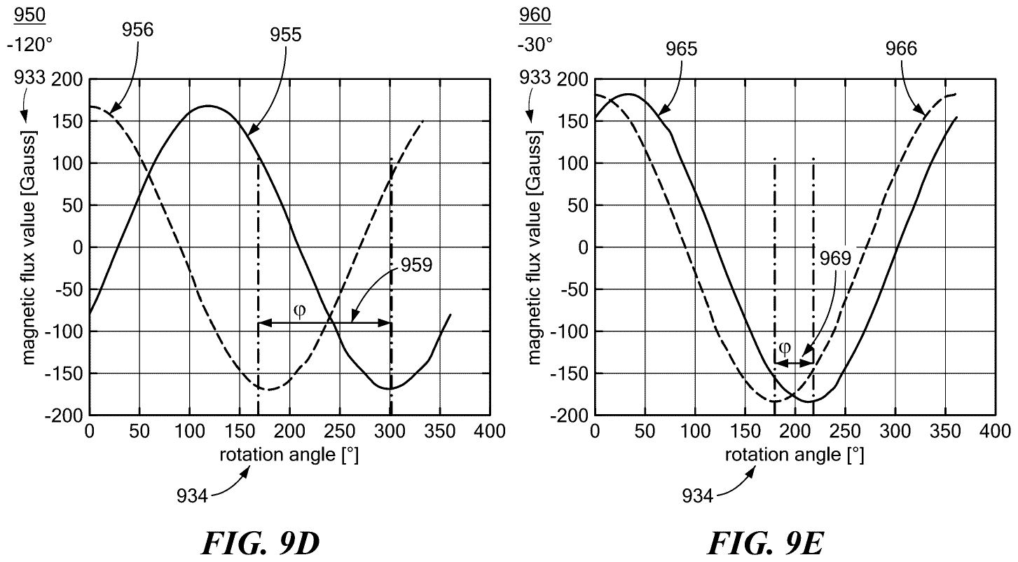

FIG. 9A shows a top view 900 of an example target showing example misplacement positions of a sensor device. Top view 900 shows example misplacement positions at misplacement position 920, misplacement position 915, misplacement position, 910, and misplacement position 905. FIGS. 9B-9E show graphs of example simulations of magnetic field strengths sensed along a Z-axis by a sensor device when the sensor device is located in different positions (e.g., positions 920, 915, 910, 905, respectively, of FIG. 9A) in a plane and the target is rotated 360 degrees. Each of these graphs has an X-axis 934 representing a rotation angle of the target in degrees, and a Y-axis 933 representing magnetic field strength (or flux) in Gauss.

For example, FIG. 9B shows a graph 930 that includes a plot 935 and a plot 936. Plot 935 corresponds to simulated magnetic field strengths measured along a Z-axis by a sensor device that is misplaced at misplacement position 920 of FIG. 9A, over 360 degrees of rotation of a target. Plot 936 corresponds to the positive cosine curve associated with the selected reference misplacement position (e.g., position 445 (“south”) of FIG. 4). As shown in FIG. 9B, the phase shift (φ) 939 between sine/cosine curve 935 and positive cosine curve 936 is 25 degrees (or −335 degrees).

FIG. 9C shows a graph 940 that includes a plot 945 and a plot 946. Plot 945 corresponds to simulated magnetic field strengths measured along a Z-axis by a sensor device that is misplaced at misplacement position 915 of FIG. 9A, over 360 degrees of rotation of a target. Plot 946 corresponds to the positive cosine curve associated with the selected reference misplacement position (e.g., position 445 (“south”) of FIG. 4). As shown in FIG. 9C, the phase shift (φ) 949 between sine/cosine curve 945 and positive cosine curve 946 is 135 degrees (or −225 degrees).

FIG. 9D shows a graph 950 that includes a plot 955 and a plot 956. Plot 955 corresponds to simulated magnetic field strengths measured along a Z-axis by a sensor device that is misplaced at misplacement position 910 of FIG. 9A, over 360 degrees of rotation of a target. Plot 956 corresponds to the positive cosine curve associated with the selected reference misplacement position (e.g., position 445 (“south”) of FIG. 4). As shown in FIG. 9D, the phase shift (φ) 959 between sine/cosine curve 955 and positive cosine curve 956 is 240 degrees (or −120 degrees).

FIG. 9E shows a graph 960 that includes a plot 965 and a plot 966. Plot 965 corresponds to simulated magnetic field strengths measured along a Z-axis by a sensor device that is misplaced at misplacement position 905 of FIG. 9A, over 360 degrees of rotation of a target. Plot 966 corresponds to the positive cosine curve associated with the selected reference misplacement position (e.g., position 445 (“south”) of FIG. 4). As shown in FIG. 9E, the phase shift (φ) 969 between sine/cosine curve 965 and positive cosine curve 966 is 330 degrees (or −30 degrees).

As discussed, by determining the phase shift (φ) between the sine/cosine curve associated with the sensor device misplacement position and the curve associated with the reference misplacement position, a radius along which the sensor device is misplaced from the center may be identified.

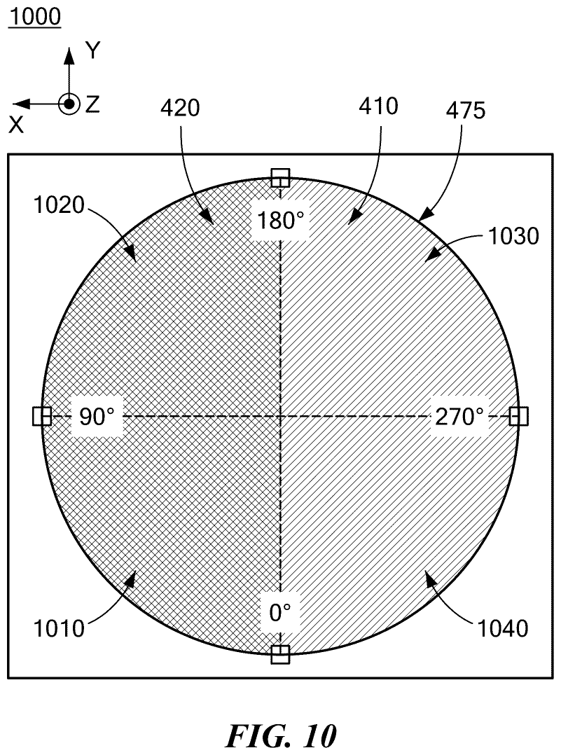

FIG. 10 shows a top view of an example target showing phase relationships between sine/cosine curves associated with magnetic field strengths sensed along a Z-axis when the sensor device is misplaced at various positions in relation to the rotation axis of the target and the target is rotated 360 degrees, with a reference misplacement position set at 0 degrees, and with the plane on which the sensor device is to be fixed split into four quadrants. If the determined phase shift of the sine/cosine curve associated with the sensor device is between 0 degrees and 90 degrees, the sensor device is misplaced somewhere along a radius in quadrant 1010. The sensor device will then need to be moved in the negative X-axis direction and the positive Y-axis direction from its current position to position the sensor device at the center position. If the determined phase shift of the sine/cosine curve associated with the sensor device is between 90 degrees and 180 degrees, the sensor device is misplaced somewhere along a radius in quadrant 1020. The sensor device will then need to be moved in the negative X-axis direction and the negative Y-axis direction from its current position to position the sensor device at the center position.

If the determined phase shift is between 180 degrees and 270 degrees, the sensor device is misplaced somewhere along a radius in quadrant 1030. The sensor device will then need to be moved in the positive X-axis direction and the negative Y-axis direction from its current position to position the sensor device at the center position. If the determined phase shift is between 270 degrees and 360 degrees, the sensor device is misplaced somewhere along a radius in quadrant 1040. The sensor device will then need to be moved in the positive X-axis direction and the positive Y-axis direction from its current position to position the sensor device at the center position.

After the phase shift between the sine/cosine curve associated with the sensor device and the curve of the selected reference misplacement position has been determined, the vector along which the sensor device is misplaced may be calculated as:

$$Equation 3$$

$$\text{misplacement vector} = ( sin φ ) x - ( cos φ ) y$$

where φ is the phase shift as discussed above with respect to Equations 1 and 2, x corresponds to the X-axis, and y corresponds to the Y-axis.

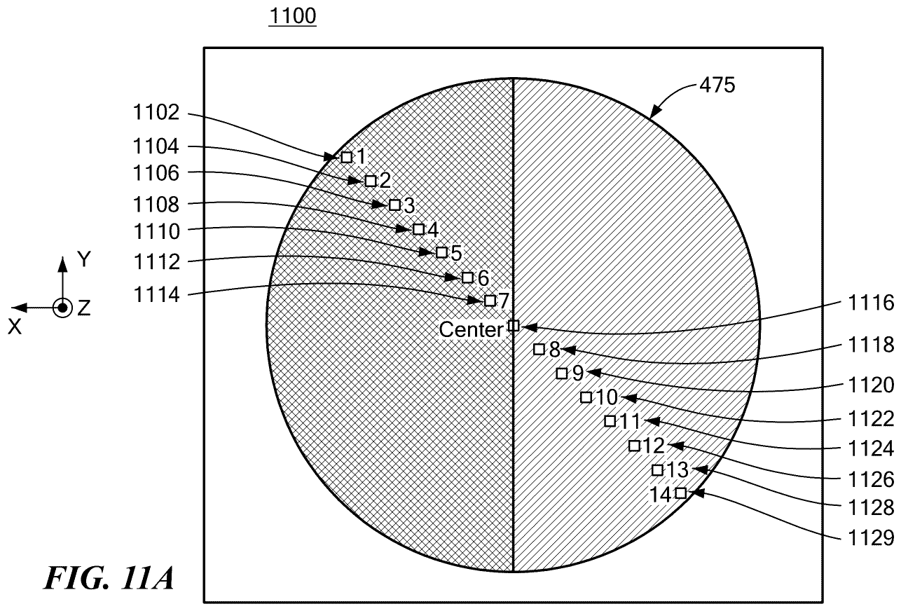

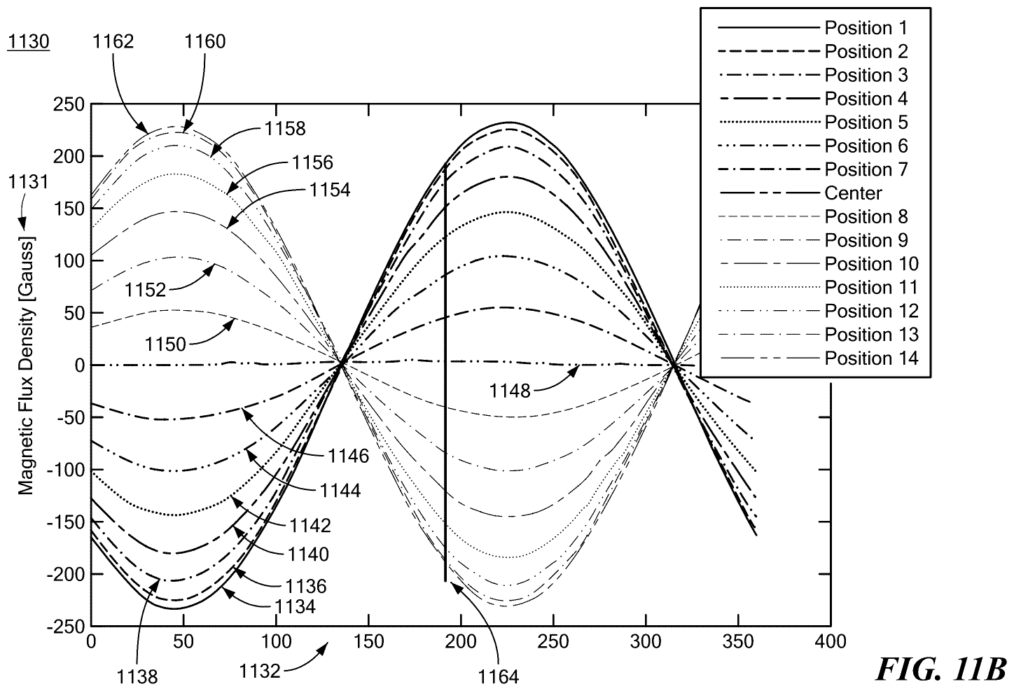

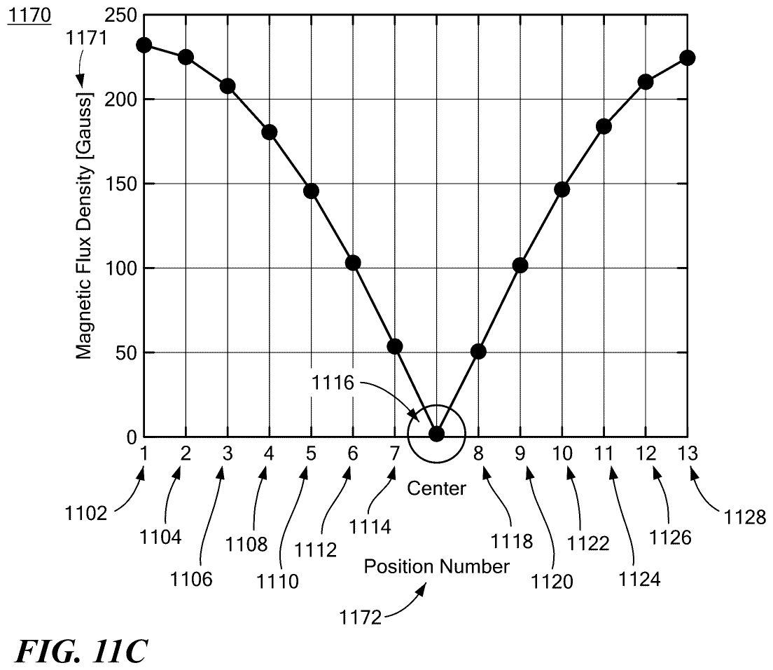

FIG. 11A shows a top view 1100 of an example target showing example positions at which a sensor device may be misplaced along a vector that bisects the target. As discussed above, a radius along which the target is misplaced may be determined based on a phase shift between the sine/cosine curve associated with the sensor device and the curve of the selected reference misplacement position. Nevertheless, for purposes of further explanation, positions along a vector across an entire diameter that bisects the target are illustrated in FIG. 11A. FIG. 11A illustrates fifteen example positions along the vector, position 1 1102, position 2 1104, position 3 1106, position 4 1108, position 5 1110, position 6 1112, position 7 1114, the center (i.e., ideally aligned) position 1116, position 8 1118, position 9 1120, position 10 1122, position 11 1124, position 12 1126, position 13 1128, and position 14 1129.

FIG. 11B shows a graph 1130 of plots of sine/cosine curves associated with simulated magnetic field strengths measured along a Z-axis when the sensor device is misplaced at the example positions shown in FIG. 10A and the target is rotated 360 degrees. Graph 1130 has an X-axis 1132 representing a rotation angle of the target in degrees, and a Y-axis 1131 representing magnetic field strength (or flux) in Gauss.

For example, plot 1134 represents the magnetic field strengths measured by a sensor device positioned at position 1 of FIG. 11A over 360 degrees of rotation of the target. Plot 1136 represents the magnetic field strengths measured by a sensor device positioned at position 2 of FIG. 11A over 360 degrees of rotation of the target. Plot 1138 represents the magnetic field strengths measured by a sensor device positioned at position 3 of FIG. 11A over 360 degrees of rotation of the target. Plot 1140 represents the magnetic field strengths measured by a sensor device positioned at position 4 of FIG. 11A over 360 degrees of rotation of the target. Plot 1142 represents the magnetic field strengths measured by a sensor device positioned at position 5 of FIG. 11A over 360 degrees of rotation of the target. Plot 1144 represents the magnetic field strengths measured by a sensor device positioned at position 6 of FIG. 11A over 360 degrees of rotation of the target. Plot 1146 represents the magnetic field strengths measured by a sensor device positioned at position 7 of FIG. 11A over 360 degrees of rotation of the target.

Plot 1148 represents the magnetic field strengths measured by a sensor device positioned at the center (i.e., ideally aligned) position of FIG. 11A over 360 degrees of rotation of the target. As shown in graph 1130, the magnetic field strength measured along a Z-axis when the sensor device is positioned at the center position is a constant 0 Gauss over 360 degrees of rotation.

Plot 1150 represents the magnetic field strengths measured by a sensor device positioned at position 8 of FIG. 11A over 360 degrees of rotation of the target. Plot 1152 represents the magnetic field strengths measured by a sensor device positioned at position 9 of FIG. 11A over 360 degrees of rotation of the target. Plot 1154 represents the magnetic field strengths measured by a sensor device positioned at position 10 of FIG. 11A over 360 degrees of rotation of the target. Plot 1156 represents the magnetic field strengths measured by a sensor device positioned at position 11 of FIG. 11A over 360 degrees of rotation of the target. Plot 1158 represents the magnetic field strengths measured by a sensor device positioned at position 12 of FIG. 11A over 360 degrees of rotation of the target. Plot 1160 represents the magnetic field strengths measured by a sensor device positioned at position 13 of FIG. 11A over 360 degrees of rotation of the target. Plot 1162 represents the magnetic field strengths measured by a sensor device positioned at position 14 of FIG. 11A over 360 degrees of rotation of the target.

FIG. 11C shows a graph 1170 of example magnetic field strengths sensed along a Z-axis when the sensor device is misplaced at the example positions shown in FIG. 11A and when the target has been rotated to an example rotation angle. The example rotation angle here is the rotation angle corresponding to line 1164 of FIG. 11B. Graph 1170 has an X-axis 1172 representing the position of the sensor device, these positions corresponding to the example positions of FIG. 11A. Graph 1170 has a Y-axis 1171 representing magnetic field strength (or flux) in Gauss.

FIGS. 11B and 11C demonstrate that, once a vector along which a sensor device is misplaced has been determined, the sensor device can be repositioned along that vector and one or more additional magnetic field strength measurements taken along a Z-axis at the new position to determine whether the sensor device has been moved toward the center position. For example, if the sensor device was at position 4, and the sensor device has been repositioned at position 6, magnetic field strength measurements along a Z-axis at each of these positions will show that the sensor device is being moved in the correct direction toward the center position, because the magnetic field strength along a Z-axis is lower at position 6 than it was at position 4. By contrast, if the sensor device was at position 4 and the sensor device has been repositioned at position 2, magnetic field strength measurements along a Z-axis at each of these positions will show that the sensor device is being moved in the wrong direction, away from the center position, because the magnetic field strength along a Z-axis is higher at position 2 than it was at position 4. The sensor device can then be moved along the vector until the magnetic field strength measurement along a Z-axis is close to zero, such that the sensor device is at or close to the center position and is highly aligned with the rotation axis of the target.

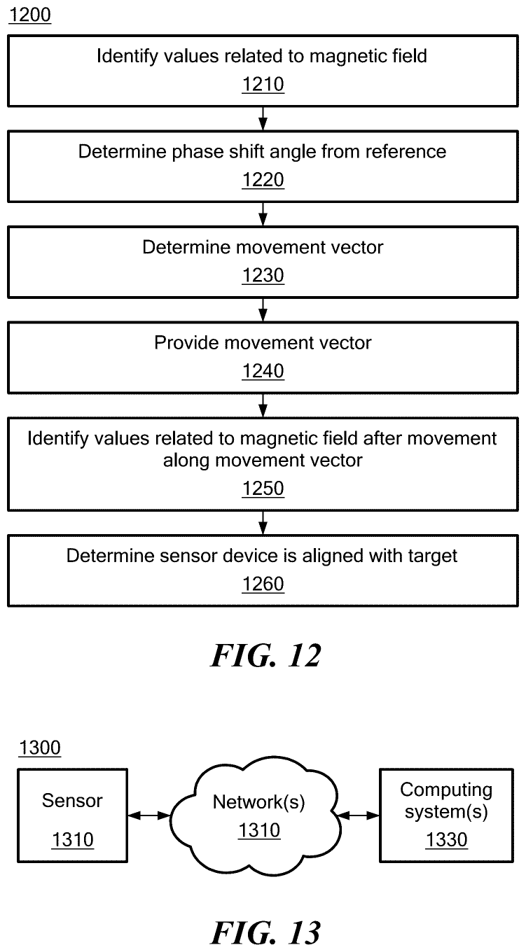

FIG. 12 shows a flow diagram of an example process 1200 for positioning a sensor device. Example process 1200 may be implemented by one or more controllers (e.g., digital controller 320) of a sensor device (e.g., sensor device 300), or by one or more computing systems (e.g., computing system(s) 1330 of FIG. 13). In some embodiments, part of process 1200 may be performed by a sensor device and part of process 1200 may be performed by one or more computing systems. Using example process 1200, controller(s) and/or computing system(s) may determine a misplacement position of a sensor device and provide for positioning the sensor device to be better aligned with a rotation axis of a target. Example process 1200 may be used, for example, when a sensor device is being calibrated and installed for a particular application, though the disclosure is not so limited.

In 1210, values related to a magnetic field may be identified. For example, a sensor device may be positioned at a location in a plane above or below a target, and the sensor device may measure magnetic field strength along a Z-axis (e.g., the rotation axis of the target or an axis parallel to the rotation axis of the target) at that position. In some embodiments, the target may be rotated 360 degrees and the sensor device may measure the magnetic field strength along a Z-axis continuously or periodically throughout the 360 degrees of rotation of the target. The magnetic field strength measurements may be recorded, along with the rotation angle at which each magnetic field strength measurement was recorded. A peak value of the magnetic field strength over the 360 degrees of rotation may be determined and used to calculate a function (e.g., positive cosine function) at a selected reference misplacement position. For example, the selected reference misplacement position may be a “south” position for which the measured magnetic field strength along a Z-axis over 360 degrees would be a positive cosine function. The peak value of the measured magnetic field strength values over 360 degrees of rotation may also be used as the peak value for the positive cosine function, and the positive cosine function may be calculated accordingly using Equation 1.

In 1220, a phase shift angle between the measured magnetic field strengths and the magnetic field strengths associated with the selected reference misplacement position may then be determined. That is, the measured magnetic field strengths may be compared with values of the calculated function (e.g., positive cosine function) associated with the selected reference misplacement position to determine the phase shift. The phase shift angle between the measured magnetic field strengths and the magnetic field strengths associated with the selected reference misplacement position may be determined in many ways. The phase shift angle may be calculated, for example, by a computing device or controller executing instructions (e.g., phase shift angle calculator instructions 311 of FIG. 3) stored in a memory (e.g., memory 324 of FIG. 3). As one example, a Hilbert transform of the measured magnetic field strength values may be calculated, and a Hilbert transform of the function (e.g., positive cosine function) corresponding to the magnetic field strengths at the selected reference misplacement position may be calculated. The results of the Hilbert transform calculations may then be used to determine the phase shift angle between the measured magnetic field strengths and the function corresponding to the selected reference misplacement position.

For example, a person of ordinary skill in the art would recognize that a Hilbert transform may be used to determine an analytic signal from a real signal. Because the measured magnetic field data may be obtained as measured magnetic field values at discrete times and not as a continuous signal, it may not be possible to estimate information such as a phase angle of the signal that would correspond to the measured data. However, through use of a Hilbert transform this information may be obtained.

A person of ordinary skill in the art would recognize that a Hilbert transform may be performed on real-valued data by first taking the Fourier transform of that data. The resulting Fourier coefficients of any negative frequencies may then be set to zero, such that they do not cancel out the imaginary part related to any positive frequencies when an inverse Fourier transform is calculated. The amplitude of the Fourier coefficients related to the positive frequencies may then be doubled to compensate for the removal of the Fourier coefficients related to the negative frequencies. Then an inverse Fourier transform may be performed. Since the imaginary components are preserved during this transformation back into the temporal domain, a complex representation of the data may be obtained that has the same information as the real-valued data, but that is an analytic signal that allows for the calculation of instantaneous quantities such as the instantaneous phase.

Such an approach may be used on the real-valued data here, which is measured magnetic field strength values at particular rotation angles of the target. For example, a Hilbert transform of the real-valued data may be performed as shown in Equation 4 below, and as further described above:

$$x * phase ( x ) = hilbert ( BZ\_data ) \qquad Equation 4$$

where BZ_data is the measured magnetic field strength values and corresponding rotation angles of the target at which the magnetic field strengths were measured, hilbert is the Hilbert transform of that data, and x*phase (x) is the result of the Hilbert transform of this data.

Similarly, a Hilbert transform may be performed on the function that corresponds to the magnetic field strengths that would be observed at the selected reference misplacement position. In the examples discussed above where the selected reference misplacement position is a south position (see position 445 (“south”) of FIG. 4), this would be a positive cosine function. Thus, a Hilbert transform of this function may be performed as shown in Equation 5 below, and as further described above:

$$x * cos ( refx ) = hilbert ( cos d ( t ) ) \qquad Equation 5$$

where t is the angle from 0 degrees to 360 degrees, cos d(t) is the amplitude of the cosine function at each t angle, hilbert is the Hilbert transform of that function, and x*cos(refx) is the result of the Hilbert transform of this data.

The phase difference between the measured magnetic field strength values and the values of the function corresponding to the reference misplacement position may then be calculated by determining the complex conjugate of the x*cos(refx) data, calculating the phase angle between the x*phase(x) data value and complex conjugate of x*cos(refx) data value at each angle, and taking the average of the calculated phase angles as the determined phase angle. This is further shown in Equation 6 below:

$$phase = mean ( angle ( x * phase ( x ) . * conj ( x * cos ( refx ) ) ) ) \qquad Equation 6$$

where x*cos(refx) is the x*cos(refx) data previously discussed, conj(x*cos(refx)) is the complex conjugate of the x*cos(refx) data, x*phase(x) is the x*phase(x) data previously discussed, angle(x*phase(x).*conj(x*cos(refx))) is the phase angle between the x*phase(x) data and the complex conjugate of the x*cos(refx) data at each angle value, mean calculates the average of the calculated phase angle values, and phase is the resulting determined phase angle between the measured magnetic field strength data and the function corresponding to the selected reference misplacement position. The resulting phase may be expressed as radians or degrees, and converted between the two, as known in the art.

For example, the phase angle between the measured magnetic field strength data and the function corresponding to magnetic field strength at the selected reference misplacement position could be calculated by a controller or processor executing instructions, such as in software, using a script like that shown below:

$$t = 0 : 1 : 360 ;$$

$$xphasex = hilbert ( BZ\_data ) ;$$

$$xcosrefx = hilbert ( cosd ( ( t ) ;$$

$$Phase = rad2deg ( mean ( angle ( xphasex . * conj ( xcosrefx ) ) ) ) .$$

Although one example technique for determining the phase shift between the measured magnetic field strength data and the function corresponding to magnetic field strength at the selected reference misplacement position has been provided, the disclosure is not so limited. Any known technique for determining a phase angle difference between two data sets, between a data set and a function, or between functions may be used, and should be considered to be encompassed within the disclosure herein.

In 1230, a movement vector may be determined. The movement vector may be determined, for example, using Equation 3 as described above. That is, the movement vector may be calculated as:

$$movement vector = ( sin φ ) x - ( cos φ ) y \qquad Equation 7$$

where φ is the phase shift determined in 1220.
The movement vector may be calculated, for example, by a computing device or controller executing instructions (e.g., movement vector calculator instructions 312) stored in a memory (e.g., memory 324).

In 1240, the movement vector may be provided. For example, if the movement vector is determined in a controller (e.g., digital controller 320), the movement vector may be provided over output interface 355 to one or more other devices (e.g., computing device 1330 of FIG. 13). Alternatively, the movement vector may be determined by a computing device (e.g., computing device 1330 of FIG. 13) and the movement vector provided by display on a screen to a user, or may be provided to another computing system, such as a computing system responsible for controlling machinery for positioning a sensor device relative to a target.

The sensor device may then be moved along the movement vector. For example, a person could move the sensor device to a different position along the movement vector. Alternatively, a machine for placing the sensor device in relation to the target could move the sensor device to a different position along the movement vector.

In 1250, values related to a magnetic field after the sensor device has been moved along the movement vector may be identified. For example, the sensor device may be positioned at a new position along the movement vector as discussed above. The sensor device may then again measure magnetic field strength along a Z-axis (e.g., the rotation axis of the target or an axis parallel to the rotation axis of the target) at the new position. In some embodiments, the target may again be rotated 360 degrees and the sensor device may measure the magnetic field strength along the Z-axis continuously or periodically throughout the 360 degrees of rotation of the target.

In some embodiments, the sensor device may be moved and 1250 performed, and this movement and identification of values may repeat any number of times until the magnetic field strength measured in a Z-axis direction is close to 0 Gauss (or a voltage representative of 0 Gauss), indicating high alignment with the rotation axis of the target. For example, the sensor device may be moved and in 1250 the magnetic field strength may be measured in a Z-axis over 360 degrees of rotation of the target. If the magnetic field strength measured by the sensor device along a Z-axis is not within a desired amount of 0 Gauss, the sensor device may be moved again and additional magnetic field strength measurements taken. In this way, the sensor device may be moved in both positive and negative directions along a movement vector until magnetic field strength measurements taken by the sensor device along a Z-axis are within a desired amount, indicating high alignment with the rotation axis of the target.

In some embodiments, the sensor may be moved and 1250 performed, and based on how much the magnetic field strength measured in a Z-axis direction has been reduced, an estimate of how much further the sensor device should be moved along the movement vector to be position the sensor device at the center can be determined.

In some embodiments, if the parameters of the target are known, the magnetic field of the target may be simulated. The simulated magnetic field strength along a Z-axis over 360 degrees of rotation of the target may then be compared to the measured magnetic field strength along a Z-axis over 360 degrees of rotation of the target to determine where the sensor device is misplaced and how far the sensor device should be moved along the movement vector to position the sensor device at the center position.

In some embodiments, an iterative algorithm may be used to determine where to move the sensor device along the movement vector and to take magnetic field measurements along a Z-axis to determine if the sensor device is centered. For example, an iterative approach may be used in which, based on the magnetic field strength measured along a Z-axis, a step size to be used in iteratively moving the sensor device toward the center may be determined. Such an approach may be similar to known gradient descent methods, though here the movement vector establishing the vector along which to move has already been determined.

In 1260, a determination may be made that the sensor device is aligned with the target. This determination may be made, for example, when the measured magnetic field strength along a Z-axis over 360 degrees of rotation of the target is nearly constant and near 0 Gauss. For example, one or more thresholds (e.g., predetermined or programmed into memory) may be set where, when the magnetic field strength measured over 360 degrees of rotation of the target is within one or more thresholds, a determination is made that the sensor device is aligned with the target.

Example process 1200 may be advantageous over traditional approaches to aligning a sensor device with a target. For example, one traditional approach to aligning a sensor device with a target in a rotation angle sensor system is to position the sensor device at many different positions in a plane above or below a target and take rotation angle measurements while rotating the target when the sensor device is located at each of these positions. These rotation angle measurements may then be compared with the known rotation angle of the target when the measurements were taken to determine the best aligned position for the sensor device. Such a process is laborious and time-consuming. Another traditional approach is to attempt to linearize the rotation angle measurements of the sensor device without attempting to reposition the sensor device. This is also a laborious and time-consuming intensive process, and can also be a processing power intensive process. Process 1200 may be used to align the sensor device with the rotation axis of a target in less steps than with traditional approaches, may minimize or eliminate the need to linearize the output of the sensor device, and may generally improve the overall accuracy of a rotation angle sensing system.

FIG. 13 is a block diagram of an example computing environment 1300 for implementing portions of the present disclosure, in accordance with some embodiments. For example, rather than performing process 1200 in one or more controllers of a sensor device, all or part of process 1200 may be implemented in one or more computing system(s) 1330 connected to a sensor device 1310 over one or more networks 1320. For example, one or more computing systems 1330 may receive one or more signals, data, or other communications from sensor device 1310, may then perform tasks of process 1200 (e.g., the more processor-intensive tasks), and may then send the results of those tasks back to sensor device 1310 for use in positioning sensor device 1310. For example, one or more calculations may be performed in computing system(s) 1330 based on signals received from sensor device 1310, and may be sent from computing system(s) 1330 to sensor device 1310 for use in positioning sensor device 1310.

As one example, the magnetic field strength data identified in 1210 may be sent from sensor device 1310 to computing system(s) 1330 over network(s) 1320. Computing system(s) 1330 may then perform 1220 to determine the phase shift angle from the function associated with the reference misplacement position, may perform 1230 to determine the movement vector, and may perform 1240 to provide the movement vector. 1250 may then be performed by the sensor device after the sensor device has been moved. 1260 may then be performed by the sensor device, with one or more controllers of the sensor device determining that the sensor device is aligned based on the measured magnetic field strength along a Z-axis being below a defined threshold value. Alternatively, sensor device 1310 may send the newly measured magnetic field strength data to computing system(s) 1330, which may then determine that sensor device 1310 is aligned with the target.

The arrangement and number of components in the computing environment is provided for purposes of illustration. Additional arrangements, numbers of components, and other modifications may be made, consistent with the present disclosure.

As shown in FIG. 13, computing environment 1300 may include a sensor device 1310. Sensor device 1310 may, for example, be a sensor device as previously described (e.g., sensor device 300 of FIG. 3). Sensor device 1310 may be coupled to one or more computing systems 1330 over one or more networks 1320. Sensor device 1310 may communicate signals, such as signals received from and/or derived from one or more magnetic field sensing elements (e.g., magnetic field sensing elements 302A, 302B, 302C of FIG. 3) to a computing system 1330 over the one or more networks 1320. The signals may, for example, be signals received from the magnetic field sensing devices representative of magnetic field strength, measured rotation angles, sample times at which magnetic field strengths or rotation angles were recorded by one or more controllers (e.g. controller 320 of FIG. 3) of sensor device 1310, or any other output described in relation to process 1200 of FIG. 12.

Network(s) 1320 may include, for example, one or more wired and/or wireless networks. By way of example, the network(s) 1320 may include a conductor over which modulated current or voltage signals may be transmitted, an Inter-Integrated Circuit (I₂C) network, a Controller Area Network (CAN) network, a WiFi network, an Ethernet network, a Universal Serial Bus (USB) network, a local area network (LAN) network, a cellular (e.g., 5G) network, and/or any other suitable type of network.

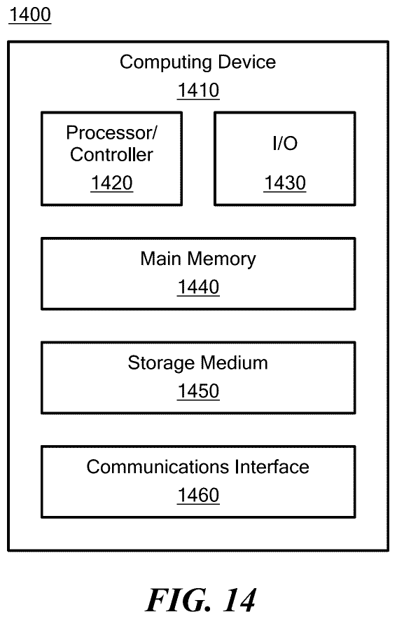

Computing system(s) 1330 may include one or more computing devices (see, e.g., computing device 1410 of FIG. 14). A computing device may be, for example, a computing device that may be used to perform some or all of process 1200 of FIG. 12. For example, rather than having to include a controller or processor with significant processing ability (and perhaps large size and/or high cost) in a sensor device, a less sophisticated controller may be included in a sensor device and signals sent to another computing device such that the other computing device may perform the more complicated and processor-intensive tasks. A computing device 1410 may be, for example, an integrated circuit connected to a sensor device. Alternatively, a computing device 1410 may be a computer, such as a laptop computer, mobile phone, tablet, personal computer, server computer, or other type of computer.

FIG. 14 is a block diagram 1400 of a computing device 1410, consistent with embodiments of the present disclosure. Computing device 1410 may, for example, perform part of all of process 1200 of FIG. 12 based on signals received over one or more networks (e.g., network(s) 1320) from a sensor device (e.g., sensor device 1310, sensor device 300). As shown in FIG. 14, a computing device 1410 may include one or more processors or controllers 1420 for executing instructions. Processors or controllers suitable for the execution of instructions may include, by way of example, both general and special purpose (e.g., application specific integrated circuit (ASIC)) processors or controllers. A computing device 1410 may also include one or more input/output (I/O) devices 1430. By way of example, I/O devices 1430 may include keys, buttons, mice, joysticks, styluses, etc. Keys and/or buttons may be physical and/or virtual (e.g., provided on a touch screen interface). A computing device 1410 may be connected to one or more displays (not shown) via I/O 1430. A display may be implemented using one or more display panels, which may include, for example, one or more cathode ray tube (CRT) displays, liquid crystal displays (LCDs), plasma displays, light emitting diode (LED) displays, touch screen type displays, organic light emitting diode (OLED) displays, or any other type of suitable display.

A computing device 1410 may include one or more storage devices configured to store data and/or software instructions used by processor(s) or controller(s) 1420 to perform operations consistent with disclosed embodiments. For example, computing device 1410 may include main memory 1440 configured to store one or more software programs that, when executed by processor(s) or controller(s) 1420, cause processor(s) or controller(s) 1420 to perform functions or operations consistent with disclosed embodiments.

By way of example, main memory 1440 may include NOR and/or NAND flash memory devices, read only memory (ROM) devices, random access memory (RAM) devices, etc. A computing device 1410 may also include one or more storage mediums 1450. By way of example, storage medium(s) 1450 may include hard drives, solid state drives, etc. A computing device 1410 may include any number of main memories 1440 and storage mediums 1450. A main memory 1440 or storage medium 1450 may, in some embodiments, be a non-transitory computer-readable medium.

A computing device 1410 may further include one or more communication interfaces 1360. Communication interface(s) 1460 may allow one or more signals to be received from a sensor device (e.g., sensor device 1310, sensor device 300) over one or more networks 1320, and may allow one or more signals to be transmitted to the sensor device. Example communication interface(s) 1360 include a modem, network interface card (e.g., Ethernet card), communications port, antenna, conductor over which current signals may be transmitted, an Inter-Integrated Circuit (I₂C) interface, a Controller Area Network (CAN) network interface, a WiFi interface, an Ethernet a Universal Serial Bus (USB) interface, a local area network (LAN) network interface, a cellular (e.g., 5G) interface, and/or any other suitable type of interface for transmitting and/or receiving signals or other information. Communication interface(s) 1460 may transmit software, data, or information in the form of signals, which may be electronic, electromagnetic, optical, and/or other types of signals. The signals may be provided to/from communications interface 1460 via a communications path (e.g., network(s) 1320), which may be implemented using wired, wireless, cable, fiber optic, radio frequency (RF), and/or other communications channels.

Although systems, methods, and techniques disclosed herein have been primarily discussed herein with respect to magnetic rotation angle sensor devices, a person of ordinary skill in the art would recognize that the systems, methods, and techniques described herein may be used to align a sensor device with a rotation axis of a target for any type of system, such as, for example, a speed sensor system. The systems, methods, and techniques were described with reference to magnetic rotation angle sensor systems by way of example to explain the details of the disclosure, but the scope of systems, methods, and techniques described herein should not be limited to these examples.

As used herein, the terms “processor” and “controller” are used to describe electronic circuitry that performs a function, an operation, or a sequence of operations. The function, operation, or sequence of operations can be hard coded into the electronic circuit or soft coded by way of instructions held in a memory device. The function, operation, or sequence of operations can be performed using digital values or using analog signals. In some embodiments, the processor or controller can be embodied in an application specific integrated circuit (ASIC), which can be an analog ASIC or a digital ASIC, in a microprocessor with associated program memory and/or in a discrete electronic circuit, which can be analog or digital. A processor or controller can contain internal processors or modules that perform portions of the function, operation, or sequence of operations. Similarly, a module can contain internal processors or internal modules that perform portions of the function, operation, or sequence of operations of the module.

While electronic circuits shown in figures herein may be shown in the form of analog blocks or digital blocks, it will be understood that the analog blocks can be replaced by digital blocks that perform the same or similar functions and the digital blocks can be replaced by analog blocks that perform the same or similar functions. Analog-to-digital or digital-to-analog conversions may not be explicitly shown in the figures but should be understood.

Various embodiments of the systems, methods, and techniques are described herein with reference to the related drawings. Alternative embodiments can be devised without departing from the scope of the described concepts. It is noted that various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to element or structure A over element or structure B include situations in which one or more intermediate elements or structures (e.g., element C) is between elements A and B regardless of whether the characteristics and functionalities of elements A and/or B are substantially changed by the intermediate element(s).

Furthermore, it should be appreciated that relative, directional or reference terms (e.g. such as “above,” “below,” “left,” “right,” “top,” “bottom,” “vertical,” “horizontal,” “front,” “back,” “rearward,” “forward,” etc.) and derivatives thereof are used only to promote clarity in the description of the figures. Such terms are not intended as, and should not be construed as, limiting. Such terms may simply be used to facilitate discussion of the drawings and may be used, where applicable, to promote clarity of description when dealing with relative relationships, particularly with respect to the illustrated embodiments. Such terms are not, however, intended to imply absolute relationships, positions, and/or orientations. For example, with respect to an object or structure, an “upper” or “top” surface can become a “lower” or “bottom” surface simply by turning the object over. Nevertheless, it is still the same surface and the object remains the same. Also, as used herein, “and/or” means “and” or “or,” as well as “and” and “or.” Moreover, all patent and non-patent literature cited herein is hereby incorporated by references in their entirety.

The terms “disposed over,” “overlying,” “atop,” “on top,” “positioned on” or “positioned atop” mean that a first element, such as a first structure, is present on a second element, such as a second structure, where intervening elements or structures (such as an interface structure) may or may not be present between the first element and the second element. The term “direct contact” means that a first element, such as a first structure, and a second element, such as a second structure, are connected without any intermediary elements or structures between the interface of the two elements. The term “connection” can include an indirect connection and a direct connection.

In the foregoing detailed description, various features are grouped together in one or more individual embodiments for the purpose of streamlining the disclosure. This method of disclosure is not to be interpreted as reflecting an intention that each claim requires more features than are expressly recited therein. Rather, inventive aspects may lie in less than all features of each disclosed embodiment.

References in the disclosure to “one embodiment,” “an embodiment,” “some embodiments,” or variants of such phrases indicate that the embodiment(s) described can include a particular feature, structure, or characteristic, but every embodiment can include the particular feature, structure, or characteristic. Moreover, such phrases are not necessarily referring to the same embodiment(s). Further, when a particular feature, structure, or characteristic is described with reference to one embodiment, knowledge of one skilled in the art may be relied upon to affect such feature, structure, or characteristic in connection with other embodiments whether or not explicitly described.

The disclosed subject matter is not limited in its application to the details of construction and to the arrangements of the components set forth in the following description or illustrated in the drawings. The disclosed subject matter is capable of other embodiments and of being practiced and carried out in various ways. As such, those skilled in the art will appreciate that the conception, upon which this disclosure is based, may readily be utilized as a basis for the designing of other structures, methods, and systems for carrying out the several purposes of the disclosed subject matter. Therefore, the claims should be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

All publications and references cited herein are expressly incorporated herein by reference in their entirety.

1. A method of aligning a sensor device to a magnetic target, comprising:
identifying values related to a magnetic field generated by the magnetic target at rotation angles of the magnetic target;
determining a phase shift angle of the sensor device from a reference point based on the identified values;
determining a movement vector based on the determined phase shift angle; and
providing the movement vector for aligning the sensor device to the magnetic target.

2. The method of claim 1, further comprising identifying values related to the magnetic field generated by the magnetic target at rotation angles of the magnetic target over 360 degrees of rotation.

3. The method of claim 1, wherein the values related to the magnetic field are identified based on signals generated by a Hall plate of the sensor device, the Hall plate being positioned perpendicular to an axis around which the magnetic target rotates.

4. The method of claim 1, wherein determining the phase shift angle further comprises:
determining phase shifts between the identified values and corresponding reference values; and
calculating an average of the determined phase shifts as the determined phase shift angle.

5. The method of claim 1, wherein determining the phase shift angle further comprises:
calculating a Hilbert transform of the identified values to determine first values;
calculating a Hilbert transform of reference values to determine second values;
calculating a complex conjugate of the determined second values to determine third values;
calculating phase shifts based on the first and third values; and
calculating an average of the phase shifts as the determined phase shift angle.

6. The method of claim 1, wherein the identified values comprise first identified values, further comprising:
identifying second values related to the magnetic field generated by the magnetic target at rotation angles of the magnetic target after the sensor device has been moved along the movement vector; and
determining that the sensor device is aligned with the magnetic target based on the identified second values.

7. The method of claim 1, wherein the movement vector is determined by calculating sine and cosine functions of the determined phase shift angle.

8. The method of claim 1, wherein a misalignment of the sensor device to the magnetic target causes at least some of the identified values to have values that are not zero.

9. The method of claim 1, wherein the identified values comprise first identified values, further comprising:
simulating a magnetic field generated by the magnetic target based on parameters of the magnetic target;
determining a distance to move the sensor device along the movement vector based on the simulated magnetic field;
identifying second values related to the magnetic field generated by the target at rotation angles of the magnetic target after the sensor device has been moved the determined distance along the movement vector; and
determining that the sensor device is aligned with the magnetic target based on the identified second values.

10. The method of claim 1, wherein the identified values comprise first identified values, further comprising iteratively determining a distance to move the sensor device along the movement vector and identifying additional values related to the magnetic field generated by the magnetic target at rotation angles of the magnetic target after each time the sensor device is moved until the identified additional values indicate that the sensor device is aligned with the magnetic target.

11. A sensor device, comprising:
a memory storing instructions; and
a controller that, when executing the instructions, is configured to:
identify values related to a magnetic field generated by a magnetic target at rotation angles of the magnetic target;
determine a phase shift angle of the sensor device from a reference point based on the identified values;
determine a movement vector based on the determined phase shift angle; and
provide the movement vector for aligning the sensor device to the magnetic target.

12. The sensor device of claim 11, wherein the controller, when executing the instructions, is further configured to identify values related to the magnetic field generated by the magnetic target at rotation angles of the magnetic target over 360 degrees of rotation.

13. The sensor device of claim 11, further comprising a Hall plate, the Hall plate being positioned perpendicular to an axis around which the magnetic target rotates.

14. The sensor device of claim 11, wherein determining the phase shift angle further comprises:
determining phase shifts between each of the identified values and corresponding reference values; and
calculating an average of the phase shifts as the determined phase shift angle.

15. The sensor device of claim 11, wherein the identified values comprise first identified values, and wherein the controller, when executing the instructions, is further configured to:
identify second values related to the magnetic field generated by the magnetic target at rotation angles of the magnetic target after the sensor device has been moved along the movement vector; and
determine that the sensor device is aligned with the magnetic target based on the identified second values.

16. The sensor device of claim 11, wherein the controller, when executing the instructions, is further configured to determine the movement vector by calculating sine and cosine functions of the determined phase shift angle.

17. The sensor device of claim 11, wherein the identified values comprise first identified values, and wherein the controller, when executing the instructions, is further configured to:
simulate a magnetic field generated by the magnetic target based on parameters of the magnetic target;
determine a distance to move the sensor device along the movement vector based on the simulated magnetic field;
identify second values related to the magnetic field generated by the magnetic target at rotation angles of the magnetic target after the sensor device has been moved the determined distance along the movement vector; and
determine that the sensor device is aligned with the magnetic target based on the identified second values.

18. The sensor device of claim 11, wherein the identified values comprise first identified values, and wherein the controller, when executing the instructions, is further configured to iteratively determine a distance to move the sensor device along the movement vector and identify additional values related to the magnetic field generated by the magnetic target at rotation angles of the magnetic target after each time the sensor device is moved until the identified additional values indicate that the sensor device is aligned with the magnetic target.

19. A non-transitory computer-readable medium storing instructions that, when executed by a processor, cause the processor to:
identify values related to a magnetic field generated by a magnetic target at rotation angles of the magnetic target;
determine a phase shift angle of a sensor device from a reference point based on the identified values;
determine a movement vector based on the determined phase shift angle; and
provide the movement vector for aligning a sensor device to the magnetic target.

20. The non-transitory computer-readable medium of claim 19, wherein the instructions, when executed, further cause the processor to identify values related to the magnetic field generated by the magnetic target at rotation angles of the magnetic target over 360 degrees of rotation.

21. The non-transitory computer-readable medium of claim 19, wherein the identified values comprise first identified values, and wherein the instructions, when executed, further cause the processor to:
identify second values related to the magnetic field generated by the magnetic target at rotation angles of the magnetic target after the sensor device has been moved along the movement vector; and
determine that the sensor device is aligned to the magnetic target based on the identified second values.

22. The non-transitory computer-readable medium of claim 19, wherein the identified values comprise first identified values, and wherein the instructions, when executed, further cause the processor to:
simulate a magnetic field generated by the magnetic target based on parameters of the magnetic target;
determine a distance to move the sensor device along the movement vector based on the simulated magnetic field;
identify second values related to the magnetic field generated by the magnetic target at rotation angles of the magnetic target after the sensor device has been moved the determined distance along the movement vector; and
determine that the sensor device is aligned with the magnetic target based on the identified second values.

23. The non-transitory computer-readable medium of claim 19, wherein the identified values comprise first identified values, and wherein the instructions, when executed, further cause the processor to iteratively determine a distance to move the sensor device along the movement vector and identify additional values related to the magnetic field generated by the magnetic target at rotation angles of the magnetic target after each time the sensor device is moved until the identified additional values indicate that the sensor device is aligned with the magnetic target.
